(19) United States
(12) Patent Application Publication
(10) Pub. No.: US 2025/0061401 A1
(43) Pub. Date: Feb. 20, 2025

(54) Techniques for AI/ML Persona-Driven Scenario Management

(71) Applicant: TEACHERS INSURANCE AND ANNUITY ASSOCIATION OF AMERICA, New York, NY (US)

(72) Inventors: Justin R. Harris-Shaw, Charlotte, NC (US); Erica Tetuan, Huntersville, NC (US); Rares loan Almasan, Paradise Valley, AZ (US); Upendra Mardikar, Fremont, CA (US)

(21) Appl. No.: 18/234,696

(22) Filed: Aug. 16, 2023

(51) Int. Cl. G06Q 10/0637

(52) U.S. Cl. CPC G06Q 10/0637

(57) ABSTRACT

Techniques for simulating transformation adoption are disclosed herein. An exemplary computer-implemented method may include receiving change data associated with an organizational change anticipated to affect members of a first group and inputting a portion of the change data into a persona model configured to generate responses representative of the first group. The persona model may be trained using a plurality of training change data and a plurality of group data as inputs to output a plurality of training responses. The exemplary method may further include generating, by executing the persona model, a response to the portion of the change data; and outputting the response for display to a user.

### TECHNICAL FIELD

The present disclosure generally relates to techniques for simulating transformation adoption, and more particularly, to creating and implementing artificial intelligence (AI) and/or machine learning (IL) driven personas for managing transformation adoption through group response simulation.

### BACKGROUND

Implementing large-scale organizational change is a time-intensive, complicated, and complex task typically requiring the management and oversight efforts of many skilled individuals. Evaluating the impact such changes may have on certain groups of people is a particularly challenging part of the overall implementation. Each group may have various characteristics, idiosyncrasies, or dependencies leading to an identical change being easily facilitated for some groups and challenging for others. Indeed, an organization may never achieve complete, successful change adoption when the impact evaluations are ill-informed.

Much of the challenge stems from conventional change/transformation adoption techniques failing to quickly and accurately understand and incorporate these various characteristics, idiosyncrasies, and/or dependencies of the wide variety of groups an organization may have. Instead, conventional change/transformation adoption techniques generally involve individuals requesting feedback from group personnel to reach a consensus for any proposed changes. This feedback request process frequently suffers from inaccurate data resulting from a lack of participation (i.e., small sample size), misunderstanding of the proposed change(s), and/or misinterpretation on behalf of the individuals collecting the feedback. Overall, conventional change/transformation adoption techniques suffer from several drawbacks that minimize the effectiveness of adopted changes, erode personnel confidence and acceptance of adopted changes, and significantly delay change adoption.

Accordingly, a need exists for techniques for creating and implementing AI and/or ML driven personas for managing transformation adoption through group response simulation to provide organizational/entity personnel with accurate, relevant impact information that may mitigate the negative effects stemming from a lack of such nuanced, readily available impact information.

### SUMMARY

As previously mentioned, conventional change (also referenced herein as “transformation”) adoption techniques suffer from a lack of flexibility in the collection, interpretation, and integration of impact information from group members that are likely to be affected by an organizational change. However, such group members frequently have documents, communications, and/or other information that contains, references, and/or otherwise indicates how and why such group members would probably respond to and/or otherwise feel about any particular organizational change (collectively referenced as “group data”). Thus, to solve these issues experienced by conventional techniques, the techniques of the present disclosure may train and implement a persona model using this group data to serve as an aggregate “group member” that may field (i.e., respond to) questions and/or other prompts related to an organizational change. In this manner, the persona model of the present disclosure may provide instantaneous, holistic, up-to-date, and accurate responses reflecting the consensus opinion(s) or thought(s) of the group members related to an organizational change. As referenced herein, a “group” may generally correspond to a set of personnel or individuals that share similar responsibilities, work as part of a similar unit (e.g., call center operators, legal staff, etc.), and/or are otherwise similar as a function of their typical duties.

One exemplary embodiment of the present disclosure may be a computer-implemented method for simulating transformation adoption. The method may include: receiving, at one or more processors, change data associated with an organizational change anticipated to affect members of a first group; inputting, by the one or more processors, a portion of the change data into a persona model configured to generate responses representative of the first group, wherein the persona model is trained using a plurality of training change data and a plurality of group data as inputs to output a plurality of training responses; generating, by the one or more processors executing the persona model, a response to the portion of the change data; and outputting, by the one or more processors, the response for display to a user.

In a variation of this embodiment, the computer-implemented method may further include: inputting, by the one or more processors, the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments; generating, by the one or more processors executing the tracking model, a performance value corresponding to the response generated by the persona model; comparing, by the one or more processors executing the tracking model, the performance value with a prior performance value to track the performance of the persona model; and generating, by the one or more processors executing the tracking model, a recommended adjustment to the persona model based on the comparing.

In another variation of this embodiment, the computer-implemented method may further include: receiving, at the one or more processors, updated change data associated with the organizational change; inputting, by the one or more processors, a portion of the updated change data into the persona model; generating, by the one or more processors executing the persona model, an updated response to the portion of the updated change data, wherein the updated response represents an updated outlook of the first group with respect to the organizational change; and outputting, by the one or more processors, the updated response for display to the user.

In yet another variation of this embodiment, the computer-implemented method may further include: aggregating, by the one or more processors, the plurality of group data that includes one or more of: (i) an internal document, (ii) an archived email, (iii) a recorded verbal conversation, or (iv) a recorded live chat; aggregating, by the one or more processors, the plurality of training change data; and training, by the one or more processors executing a training module, the persona model with the plurality of training change data and the plurality of group data as inputs to generate the plurality of training responses as outputs.

In still another variation of this embodiment, the persona model may include a plurality of persona models; each persona model of the plurality of persona models may be configured to generate responses representative of a respective subset of the first group, each respective subset of the first group representing a different perspective with respect to the organizational change from every other respective subset of the first group; each persona model of the plurality of persona models may be trained using the plurality of change data and a plurality of subset group data as inputs to output a respective plurality of training responses; and the method may further include: inputting, by the one or more processors, the portion of the change data into the plurality of persona models, generating, by the one or more processors executing the plurality of trained persona models, a plurality of responses to the portion of the change data, and outputting, by the one or more processors, the plurality of responses for display to the user.

In yet another variation of this embodiment, the response may include at least one of: (i) a predicted subsequent response strategy to address the first group, (ii) a change receptiveness likelihood value, (iii) a predicted uptake time value, (iv) a best practices indication, (v) a successful adoption likelihood value, (vi) an estimated timeline for adoption, or (vii) a realization value.

In still another variation of this embodiment, the computer-implemented method may further include: extracting, by the one or more processors, the portion of the change data from the change data; creating, by the one or more processors, a formatted input that includes a plurality of prompts for the persona model based on the portion of the change data; and inputting, by the one or more processors, the formatted input into the persona model as part of the portion of the change data.

In yet another variation of this embodiment, the computer-implemented method may further include: receiving, at the one or more processors, a first verbal communication of the portion of the change data; converting, by the one or more processors, the first verbal communication to a first text string representing the portion of the change data; generating, by the one or more processors executing the persona model, the response to the portion of the change data as a second text string; converting, by the one or more processors, the second text string to a second verbal communication; and causing, by the one or more processors, the second verbal communication to be conveyed to the user.

Another exemplary embodiment of the present disclosure may be a system for simulating transformation adoption. The system may include: one or more processors; and a non-transitory computer-readable memory coupled to the one or more processors and the user interface, the memory storing instructions thereon that, when executed by the one or more processors, cause the one or more processors to: receive change data associated with an organizational change anticipated to affect members of a first group, input a portion of the change data into a persona model configured to generate responses representative of the first group, wherein the persona model is trained using a plurality of training change data and a plurality of group data as inputs to output a plurality of training responses, generate, by executing the persona model, a response to the portion of the change data, and output the response for display to a user.

In a variation of this embodiment, the instructions, when executed, may further cause the one or more processors to: input the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments; generate, by executing the tracking model, a performance value corresponding to the response generated by the persona model; compare, by executing the tracking model, the performance value with a prior performance value to track the performance of the persona model; and generate, by executing the tracking model, a recommended adjustment to the persona model based on the comparing.

In another variation of this embodiment, the instructions, when executed, may further cause the one or more processors to: receive updated change data associated with the organizational change; input a portion of the updated change data into the persona model; generate, by executing the persona model, an updated response to the portion of the updated change data, wherein the updated response represents an updated outlook of the first group with respect to the organizational change, and output the updated response for display to the user.

In yet another variation of this embodiment, the instructions, when executed, may further cause the one or more processors to: aggregate the plurality of group data that includes one or more of: (i) an internal document, (ii) an archived email, (iii) a recorded verbal conversation, or (iv) a recorded live chat; aggregate the plurality of training change data; and train, by executing a training module, the persona model with the plurality of training change data and the plurality of group data as inputs to generate the plurality of training responses as outputs.

In still another variation of this embodiment, the persona model may include a plurality of persona models; each persona model of the plurality of persona models may be configured to generate responses representative of a respective subset of the first group, each respective subset of the first group representing a different perspective with respect to the organizational change from every other respective subset of the first group; each persona model of the plurality of persona models may be trained using the plurality of change data and a plurality of subset group data as inputs to output a respective plurality of training responses; and the instructions, when executed, may further cause the one or more processors to: input the portion of the change data into the plurality of persona models, generate, by executing the plurality of trained persona models, a plurality of responses to the portion of the change data, and output the plurality of responses for display to the user.

In yet another variation of this embodiment, the response may include at least one of: (i) a predicted subsequent response strategy to address the first group, (ii) a change receptiveness likelihood value, (iii) a predicted uptake time value, (iv) a best practices indication, (v) a successful adoption likelihood value, (vi) an estimated timeline for adoption, or (vii) a realization value.

In still another variation of this embodiment, the instructions, when executed, may further cause the one or more processors to: extract the portion of the change data from the change data; create a formatted input that includes a plurality of prompts for the persona model based on the portion of the change data; and input the formatted input into the persona model as part of the portion of the change data.

Yet another exemplary embodiment of the present disclosure is a tangible machine-readable medium comprising instructions for simulating transformation adoption that, when executed, cause a machine to at least: receive change data associated with an organizational change anticipated to affect members of a first group; input a portion of the change data into a persona model configured to generate responses representative of the first group, wherein the persona model is trained using a plurality of training change data and a plurality of group data as inputs to output a plurality of training responses; generate, by executing the persona model, a response to the portion of the change data; and output the response for display to a user.

In a variation of this embodiment, the instructions, when executed, may further cause the machine to at least: input the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments; generate, by executing the tracking model, a performance value corresponding to the response generated by the persona model; compare, by executing the tracking model, the performance value with a prior performance value to track the performance of the persona model; and generate, by executing the tracking model, a recommended adjustment to the persona model based on the comparing.

In another variation of this embodiment, the instructions, when executed, may further cause the machine to at least: receive updated change data associated with the organizational change; input a portion of the updated change data into the persona model; generate, by executing the persona model, an updated response to the portion of the updated change data, wherein the updated response represents an updated outlook of the first group with respect to the organizational change; and output the updated response for display to the user.

In yet another variation of this embodiment, the instructions, when executed, may further cause the machine to at least: aggregate the plurality of group data that includes one or more of: (i) an internal document, (ii) an archived email, (iii) a recorded verbal conversation, or (iv) a recorded live chat; aggregate the plurality of training change data; and train, by executing a training module, the persona model with the plurality of training change data and the plurality of group data as inputs to generate the plurality of training responses as outputs.

In still another variation of this embodiment, the persona model may include a plurality of persona models; each persona model of the plurality of persona models may be configured to generate responses representative of a respective subset of the first group, each respective subset of the first group representing a different perspective with respect to the organizational change from every other respective subset of the first group; each persona model of the plurality of persona models may be trained using the plurality of change data and a plurality of subset group data as inputs to output a respective plurality of training responses; and the instructions, when executed, may further cause the machine to at least: input the portion of the change data into the plurality of persona models, generate, by executing the plurality of trained persona models, a plurality of responses to the portion of the change data, and output the plurality of responses for display to the user.

In accordance with the above, and with the disclosure herein, the present disclosure includes improvements in computer functionality or in improvements to other technologies at least because the disclosure describes that, e.g., a hosting server (e.g., central server), or otherwise computing device (e.g., a user computing device), is improved where the intelligence or predictive ability of the hosting server or computing device is enhanced by a trained persona model. This model, executing on the hosting server or user computing device, is able to accurately and efficiently determine relevant responses that represent a group or collective of people. That is, the present disclosure describes improvements in the functioning of the computer itself or “any other technology or technical field” because a hosting server or user computing device, is enhanced with a trained persona model to accurately detect, evaluate, predict, and generate group query responses configured to improve an entity's transformation adoption efforts related to the entity's personnel and associated devices. This improves over the prior art at least because existing systems lack such evaluative and/or predictive functionality, and are generally unable to accurately analyze such prompts on a real-time basis to output predictive and/or otherwise recommended responses that reflect an entire personnel group and are designed to improve an entity's overall transformation adoption efforts related to the entity's personnel and associated devices.

As mentioned, the model(s) may be trained using machine learning and may utilize machine learning during operation. Therefore, in these instances, the techniques of the present disclosure may further include improvements in computer functionality or in improvements to other technologies at least because the disclosure describes such models being trained with a plurality of training data (e.g., 10,000 s of training data corresponding to the group members, change data, input prompts, etc.) to output the relevant query responses configured to improve the entity's transformation efforts related to the entity's personnel and associated devices.

Moreover, the present disclosure includes effecting a transformation or reduction of a particular article to a different state or thing, e.g., transforming or reducing the overall system processing demand and transformation adoption rate of an entity's associated personnel and devices from a non-optimal or error state to an optimal state by eliminating untimely, irrelevant, and/or otherwise erroneous input from group members when determining/implementing actions to facilitate transformation adoption.

Still further, the present disclosure includes specific features other than what is well-understood, routine, conventional activity in the field, or adding unconventional steps that demonstrate, in various embodiments, particular useful applications, e.g., receiving, at one or more processors, change data associated with an organizational change anticipated to affect members of a first group; inputting, by the one or more processors, a portion of the change data into a persona model configured to generate responses representative of the first group, wherein the persona model is trained using a plurality of training change data and a plurality of group data as inputs to output a plurality of training responses; and/or generating, by the one or more processors executing the persona model, a response to the portion of the change data.

### BRIEF DESCRIPTION OF THE DRAWINGS

The Figures described below depict various aspects of the system and methods disclosed therein. It should be understood that each Figure depicts an embodiment of a particular aspect of the disclosed system and methods, and that each of the Figures is intended to accord with a possible embodiment thereof. Further, wherever possible, the following description refers to the reference numerals included in the following Figures, in which features depicted in multiple Figures are designated with consistent reference numerals.

There are shown in the drawings arrangements which are presently discussed, it being understood, however, that the present embodiments are not limited to the precise arrangements and instrumentalities shown, wherein:

FIG. 1A depicts an exemplary computing environment in which various embodiments of the present disclosure may be implemented.

FIG. 1B depicts an exemplary computing system in which various embodiments of the present disclosure may be implemented.

FIG. 2A depicts a first exemplary workflow for data input/output of a computing device, in accordance with various embodiments described herein.

FIG. 2B depicts a second exemplary workflow for data input/output of a computing device, in accordance with various embodiments described herein.

FIG. 3 depicts an exemplary graphical user interface (GUI) that may be displayed on a computing device, in accordance with various embodiments described herein.

FIG. 4 depicts a flow diagram representing an exemplary computer-implemented method, in accordance with various embodiments described herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

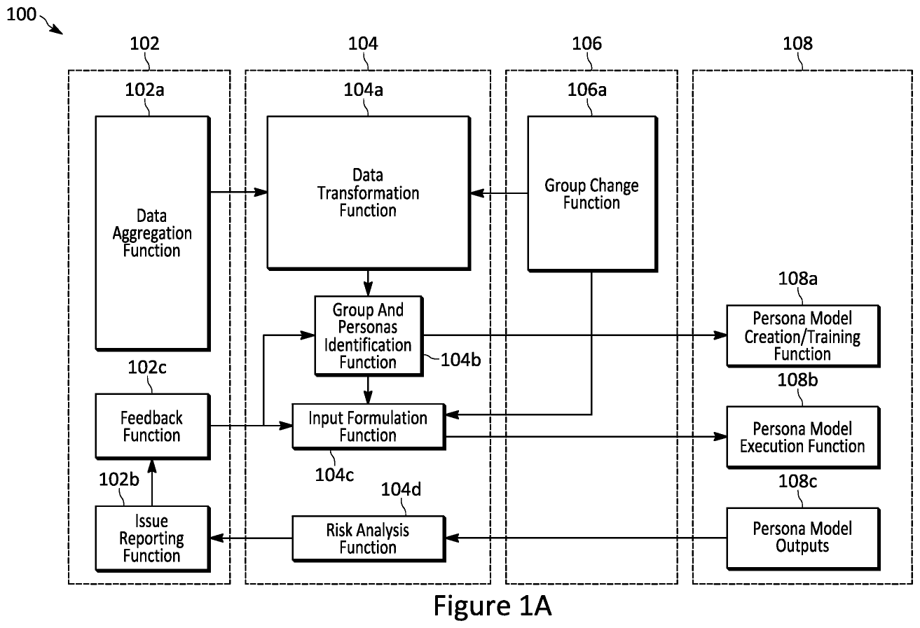

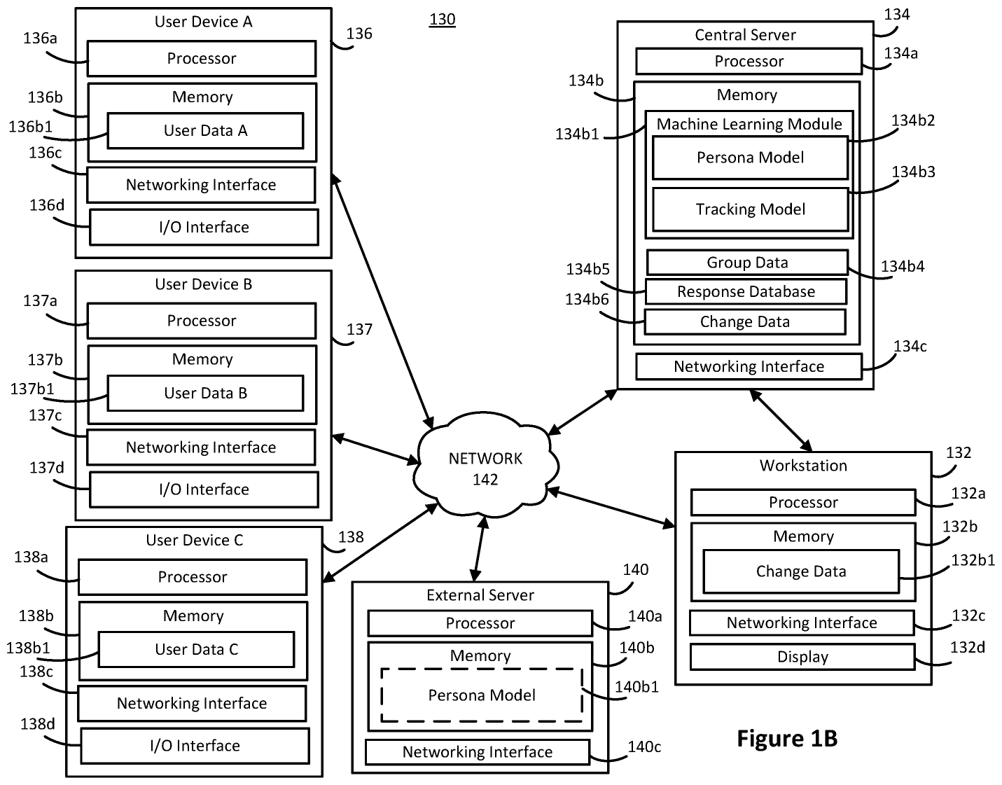

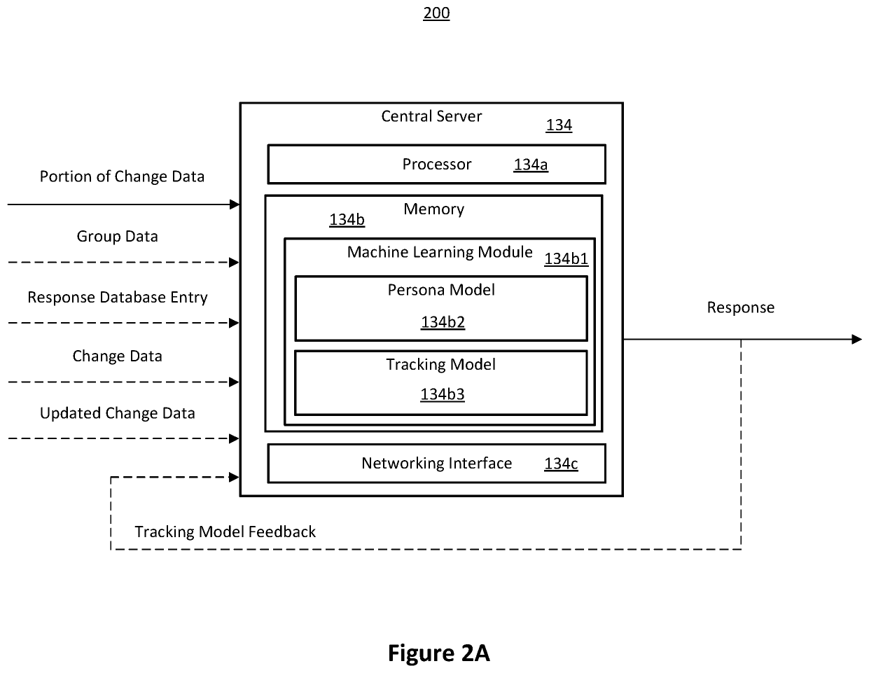

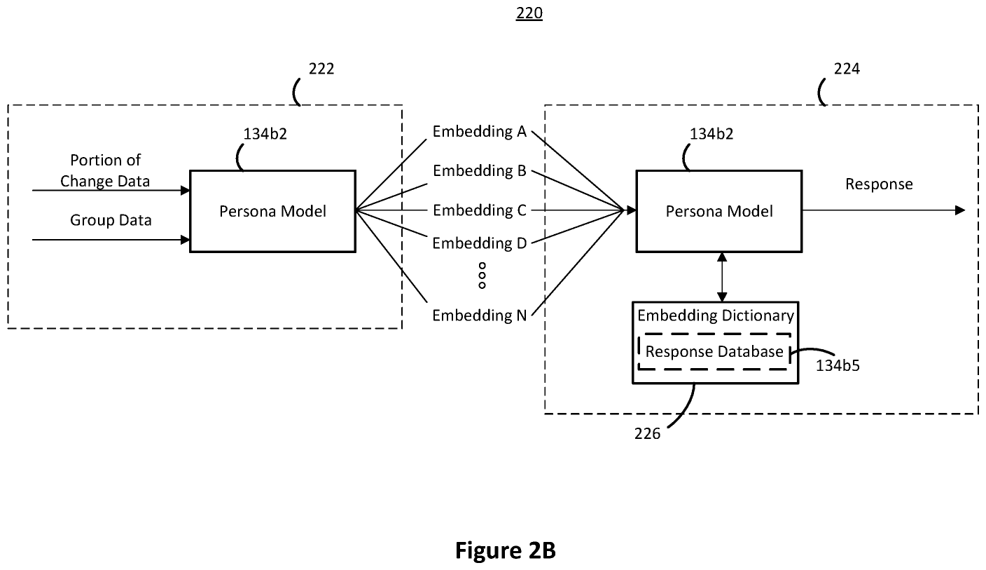

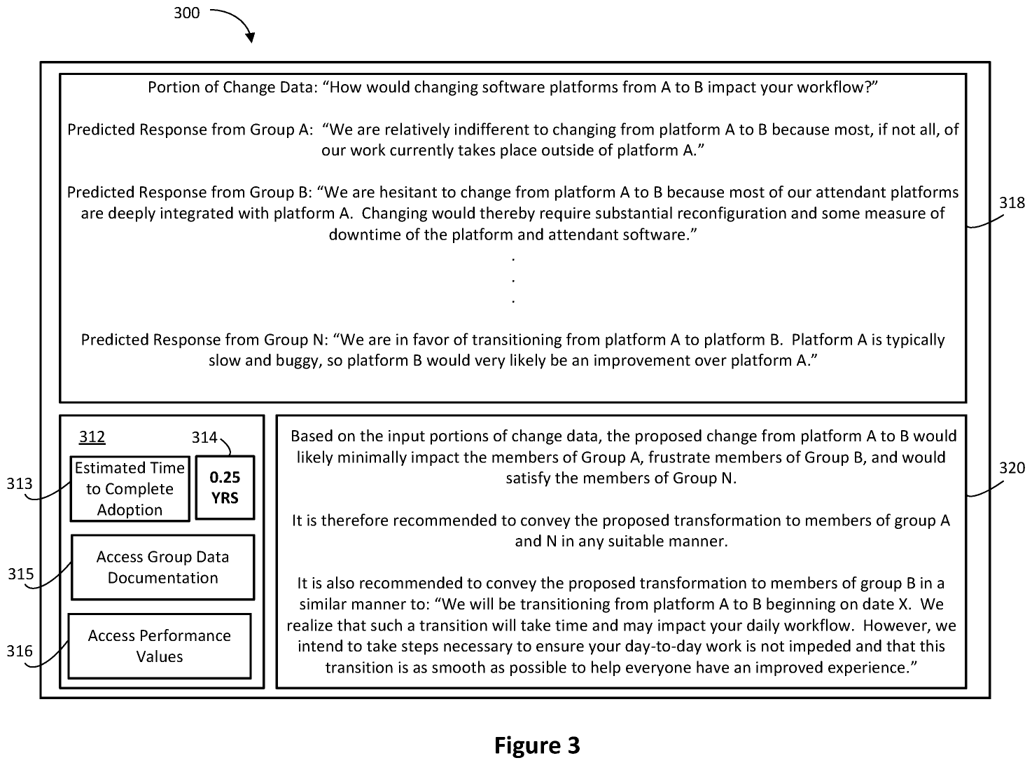

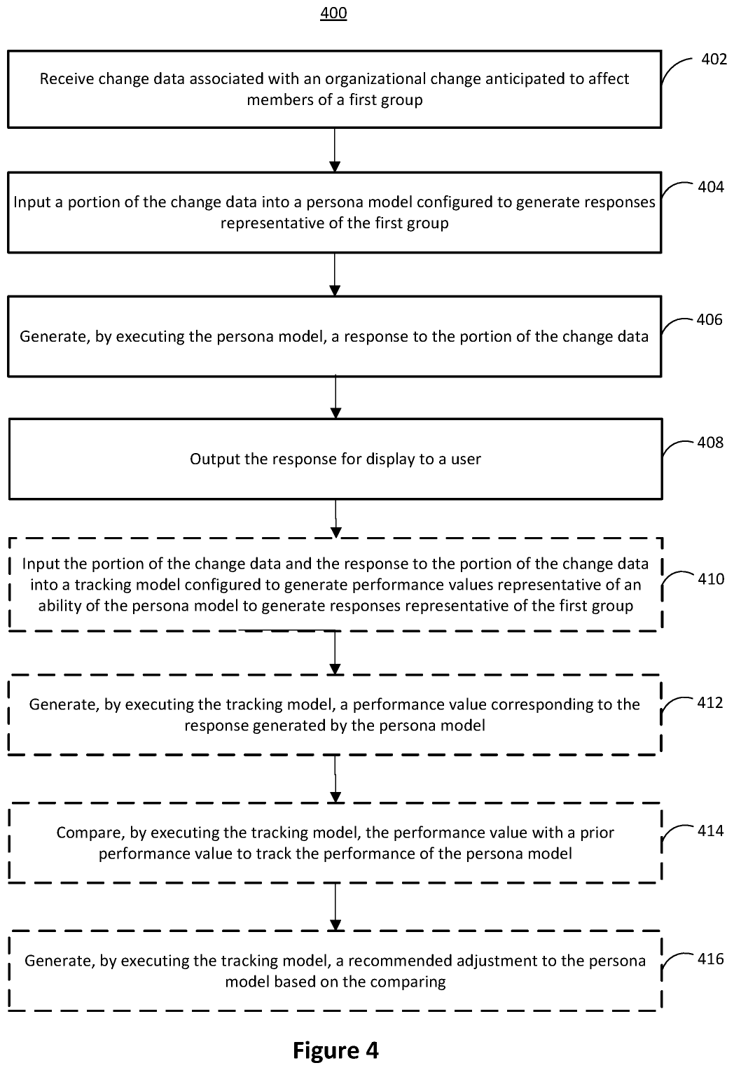

As previously mentioned, the systems and methods of the present disclosure generally relate to improving transformation adoption through simulation using trained persona models (referenced herein as “persona models”). To provide a better understanding of the systems and methods described herein, FIGS. 1A and 1B depict exemplary computing environments in which techniques of the present disclosure may be implemented, and FIGS. 2A and 2B illustrate how some of these system components may be trained and/or otherwise configured to process prompts and/or other data to generate responses and/or other output. FIG. 3 depicts an exemplary GUI that may feature and/or otherwise display information included as part of and/or extracted from the generated responses and/or other output. FIG. 4 illustrates an exemplary computer-implemented method workflow for simulating transformation adoption and how such transformation simulation may improve the transformation adoption process.

### Exemplary Computing System

FIG. 1A depicts and exemplary computing environment 100 in which various embodiments of the present disclosure may be implemented. Broadly speaking, the exemplary computing environment 100 may illustrate the types of data and/or specific processing actions and/or transmissions taking place within and/or between/among such various computing devices to facilitate the transformation adoption simulation described herein. The exemplary computing environment 100 may utilize and/or otherwise access one or more computing devices (e.g., on-premise server(s), cloud-based server(s), desktop/laptop computers, smartphones and/or other smart devices, or the like) that are communicatively connected (e.g., via a network connection) to one another and are configured to transmit, receive, and process data related to organizational change/transformation corresponding to an entity/organization that owns and/or otherwise accesses/utilizes the computing devices. Thus, it is to be understood that the specific hardware/software components described in reference to FIG. 1A are for the purposes of discussion only, and that each of the actions described herein in reference to FIG. 1A may take place on and/or using any suitable number of underlying hardware/software components.

As an example, a first entity may own each of the computing devices that perform the actions represented within the exemplary computing environment 100. In this example, the data flow illustrated in FIG. 1A may thereby take place entirely within the set of computing devices owned by the first entity, such that external data sources and/or other external computing devices are not accessed. However, in other examples, portions of the computing devices performing the actions represented within the exemplary computing environment 100 may not be owned and/or may otherwise exist outside of the first entity's internal hardware/software architecture. To illustrate, the AI level 108 of the exemplary computing environment 100 may be performed on a cloud-based AI platform.

In any event, the exemplary computing environment 100 includes four primary data processing levels: a planning/analysis level 102, an enterprise change level 104, a group change level 106, and the AI level 108. Each of these levels 102, 104, 106, 108 includes various data processing and/or storage actions that may influence the corresponding actions of other levels 102, 104, 106, 108.

The planning/analysis level 102 includes a data aggregation function 102a, an issue reporting function 102b, and an analysis and feedback function 102c. The data aggregation function 102a generally involves the aggregation of various data that may be used as inputs to a persona model and/or that are otherwise utilized during the transformation adoption simulation process embodied by the exemplary computing environment 100 of FIG. 1A. For example, the data aggregation function 102a may include aggregating structured data (e.g., transactional data, operational data), unstructured/semi-structured data (e.g., prior responses from group members, group data, or the like), change data, and/or any other suitable data or combinations thereof.

The issue reporting function 102b and the analysis and feedback function 102c both utilize data output from a persona model(s) to inform and improve the performance of the persona model(s) in future iterations. Namely, the issue reporting function 102b may generate, receive, report, and/or otherwise manage outputs from a persona model to yield potential areas of improvement for the persona model(s) during subsequent iterations. The analysis and feedback function 102c may interpret these potential areas of improvement, along with corresponding data, to determine adjustments to the training of the persona model(s) that may be implemented during subsequent iterations. The issue reporting function 102b and/or the analysis and feedback function 102c may utilize and/or otherwise leverage a tracking model that is configured to generate performance values representative of an ability of the persona model(s) to generate responses representative of a particular group, and the performance value(s) may also include, reference, and/or otherwise encapsulate the potential areas of improvement for the persona model. Further, the performance value may represent a degree to which the persona model (a) provides outputs representing the opinions, thoughts, and/or concerns of particular groups, (b) provides impactful, effective recommendations in response to certain inputs, and/or provides any other suitable outputs or combinations thereof.

As an example, a persona model may initially receive inputs (e.g., at an early/first stage in the transformation adoption process) related to a first group and may generate initial outputs indicating, referencing, and/or otherwise causing the risk analysis function 104d to derive potential risks and/or issues corresponding to the first group that include issues, B, C, and D. Accordingly, the recommendations output by the persona model, the risk analysis function 104d, and/or otherwise stemming from the initial outputs of the persona model may include recommended solutions to avoid issues B, C, and D.

Continuing the prior example, the persona model may receive subsequent inputs (e.g., at a later/second stage in the transformation adoption process) related to the first group and may provide subsequent outputs (e.g., persona model outputs 108c) indicating that the first group is falling behind in the planned/estimated adoption schedule, and the subsequent outputs may indicate several potential reasons for the first group's latency. The subsequent outputs may then pass through the risk analysis function 104d, as discussed further herein, which may determine that the first group is falling behind in their transformation adoption efforts specifically due to issues A, B, and C. The persona model outputs and the outputs from the risk analysis function 104d may reach the issue reporting function 102b, which may execute the tracking model to generate a performance value of the persona model. The performance value in this example may be relatively low because two of the issues determined by the risk analysis function 104d (e.g., A, B, C) from the subsequent outputs of the persona model are also present in, derived from, and/or otherwise referenced in the initial outputs of the persona model. Therefore, the issue reporting function 102b and/or the analysis and feedback function 102c may determine that the persona model is not functioning optimally because some of the issues initially identified for the first group have remained issues for the first group at the time of the subsequent iteration.

The analysis and feedback function 102c may then interpret this performance value to determine that the persona model should be re-trained and/or otherwise adjusted to better handle instances in which the first group, issues B and C, and/or any other data indicated in both the initial outputs and the subsequent outputs of the persona model are similar and/or identical. The analysis and feedback function 102c may generate, for example, weighting parameter adjustments, re-training data set recommendations, model rule adjustments, and/or any other suitable feedback that may apply to the persona model, as well as adjustments to deliverables transmitted to group members. For example, the analysis and feedback function 102c may determine that the persona model failed to optimally account for and/or respond to issue B from the perspective of the first group. Accordingly, the analysis and feedback function 102c may recommend re-training of the persona model to avoid such non-optimal outputs during future iterations and may also recommend adjustments to communications and/or other interactions (e.g., recommend more/less direct intervention, increase first group training efforts, etc.) with the first group due to the persistent nature of issue B plaguing the first group in their efforts to adopt the transformation.

The enterprise change level 104 generally includes a data transformation function 104a, a groups and personas identification function 104b, an input formulation function 104c, and the risk analysis function 104d. The data transformation function 104a involves ingesting the data aggregated during the data aggregation function 102a, processing and/or storing change data information that is related to one or more of the persona models, and/or warehousing or storing any data involved as part of the exemplary computing environment 100. For example, the data transformation function 104a may receive and/or pull group data and/or change data from the data aggregation function 102a.

The groups and personas identification function 104b includes analysis and development of one or more persona models that is/are or should be trained to reflect a particular group of personnel. For example, the groups and personas identification function 104b may include analyzing data stored, received, and/or otherwise accessible through the data transformation function 104a to determine a first persona model that should be created/trained to provide outputs representative of a first group of personnel. Based on these determinations, the groups and personas identification function 104b may transmit signals to the persona model creation/training function 108a to perform the first persona model creation/training, as described herein.

The input formulation function 104c may generally receive data from the analysis and feedback function 102c, the groups and personas identification function 104b, the group change function 106a, and/or any other suitable function or location to generate input (e.g., prompts) for the persona models. For example, the input formulation function 104c may receive data indicating that a first persona model has just been created and trained, and that the first group represented by the first persona model is anticipated to be affected by a first organizational transformation. In this example, the input formulation function 104c may generate a questionnaire or other suitable prompt(s) for input to the first persona model. The input formulation function 104c may also include transmitting and/or otherwise inputting the questionnaire and/or other suitable prompt into the first persona model to generate outputs, as described herein.

As previously mentioned, the risk analysis function 104d may generally analyze outputs from the persona model(s) to determine certain specific risks and/or issues that may arise or have arisen based on the outputs of the persona model(s). For example, the risk analysis function 104d may receive outputs (i.e., responses) from a first persona model indicating that a first group corresponding to the first persona model are likely to exceed adoption goals (e.g., quicker-than-expected transition, higher than average literacy, etc.) for a particular transformation, as the consensus opinion reflected in the first persona model outputs is overwhelmingly positive. In response, the risk analysis function 104d may analyze these outputs to identify potential risks that could reduce the likelihood that the first group exceeds the adoption goals. Namely, the risk analysis function 104d may determine that first group may, in fact, begin falling behind in their transformation adoption efforts if issues X and Y are not addressed in a particular time frame.

Moreover, in certain embodiments, the risk analysis function 104d may also generate reports or other deliverables that may present and/or otherwise convey the information distilled from the persona model(s) to a user. Continuing the above example, the risk analysis function 104d may take the outputs from the first persona model and format them, along with the potential issues X and Y identified by the risk analysis function 104d, into a document, presentation, and/or other suitable format or combinations thereof. Further, in certain circumstances, the risk analysis function 104d may automatically generate and/or otherwise initiate a communication (e.g., email message, text message, phone call, instant/web chat) with a user to convey the information received and generated based on the persona model outputs.

The group change level 106 may broadly represent how group data may be received, stored, updated, and/or otherwise utilized in the transformation adoption simulation process characterized by the exemplary computing environment 100. The group change level 106 includes the group change function 106a, which includes group data storage and management, such as data access and management permissions, data searching rules, data governance and integration security operations, and/or any other suitable group data rules or combinations thereof. For example, if a security rule for a first group changes, then that updated security rule may be stored as part of the group change function 106a and may be transmitted for integration into the decision-making of the input formulation function 104c.

The AI level 108 may include functions related to the persona models described herein. The AI level 108 may include the persona model creation/training function 108a, a persona model execution function 108b, and persona model outputs 108c. As mentioned, the persona model creation/training function 108a may perform persona model creation/training using data received from the groups and personas identification function 104b. The persona model creation/training function 108a may generally leverage AI and/or ML techniques to train persona models using a plurality of training change data and a plurality of group data as inputs to output a plurality of training responses.

The persona model execution function 108b may represent the created/trained persona models being executed to process inputs (e.g., prompts) from the input formulation function 104c to generate the persona model outputs 108c. Namely, the persona model execution function 108b may include receiving and inputting a portion of change data into a persona model configured to generate responses representative of a first group. The persona model execution function 108b may then also include generating the persona model outputs 108c as a response to the portion of the change data. Generally, the portions of change data input into the persona model for execution may be or include prompts generated as part of the input formulation function 104c that include, reference, and/or are otherwise indicative of the change data received at the data aggregation function 102a, the data transformation function 104a, and/or any other suitable function or location represented by the exemplary computing environment 100 of FIG. 1A.

FIG. 1B depicts an exemplary computing system 130 in which various embodiments of the present disclosure may be implemented. Namely, the exemplary computing system 130 may be or include the various computing devices and/or components that execute some/all of the functions described herein in reference to FIG. 1A. Depending on the embodiment, the exemplary computing system 130 may train a persona model (e.g., persona model 134b2, 140b1) and/or a tracking model (e.g., tracking model 134b3), and/or may generate responses to prompts and/or recommendations based on such prompts, and/or any other values, responses, or combinations thereof. Of course, it should be appreciated that, while the various components of the exemplary computing system 130 (e.g., workstation 132, central server 134, user device A 136, user device B 137, user device C 138, external server 140, etc.) are illustrated in FIG. 1B as single components, the exemplary computing system 130 may include multiple (e.g., dozens, hundreds, thousands) of each of the components that are simultaneously connected to the network 142 at any given time.

Generally speaking, the exemplary computing system 130 may include a central server 134, a workstation 132, a user device A 136, a user device B 137, a user device C 138, and an external server 140. In certain embodiments, the exemplary computing system 130 may be or include components of a system configured to perform a particular task or series of functions, such as a call center or other suitable organization. For example, the exemplary computing system 130 may be or include a contact center configured to field incoming calls, web-based chats, video communications, and/or any other suitable communications or combinations thereof from users connecting to the communication system (e.g., via the user device A 136). However, in other embodiments, the user device A 136, the user device B 137, and the user device C 138 may each be devices utilized by internal users of the organization/entity that owns and/or otherwise provisions the exemplary computing system 130. For example, each of the user device A 136, the user device B 137, and the user device C 138 may be devices commissioned to agents of a call center.

In any event, the central server 134 may generally receive and store group data 134b4 corresponding to the users of user device A 136, user device B 137, and user device C 138, and may process the data in accordance with one or more sets of instructions contained in the memory 134b to output any of the values/responses previously described. For example, the central server 134 may receive the user data A 136b1, the user data B 137b1, and/or the user data C 138b1 from the user devices 136, 137, 138, and may process this data 136b1, 137b1, 138b1 to generate and/or update the group data 134b4 corresponding to the respective groups for each of the various users of the devices 136, 137, 138. Moreover, the data the central server 134 receives may be or include a text string, an audio stream, a video stream, a file, a document, and/or any other suitable data/datatype or combinations thereof.

The central server 134 may include one or more processors 134a, the memory 134b, and a networking interface 134c. The memory 134b may include various sets of executable instructions that are configured to analyze data received at the central server 134 and analyze that data to output various values. These executable instructions include, for example, a machine learning module 134b1 (also referenced herein as a “training module”), a persona model 134b2, and a tracking model 134b3. The memory 134b may also store additional data and/or databases, such as group data 134b4, a response database 134b5, and change data 134b6.

The persona model 134b2 may generally be an artificial intelligence (AI) trained large language algorithm/model (LLM) that is configured to interact with a user that is accessing the exemplary computing system 130. As a general example, when a user inputs a prompt into the central server 134 (e.g., via workstation 132), the user's inputs and any subsequent responses may be analyzed by the persona model 134b2 to generate outputs, such as predicted responses to such prompts. In particular, the persona model 134b2 may utilize the initial outputs (e.g., portions of change data 132b1, 134b6, group data 134b4, etc.) to generate subsequent responses that may be transmitted and displayed/conveyed to the user through the workstation 132. In certain embodiments, the central server 134 may train/re-train the persona model 134b2 during live communications across communications channels (e.g., a live webchat, a phone call, an email, a text message, a video call, etc.) to improve the subsequent iterations of the persona model 134b2.

In certain embodiments, the persona model 134b2 may be configured to output responses that are or include recommendations for a stylistic or contextual communication type. For example, the central server 134 may receive a prompt from a user (e.g., via workstation 132) requesting information from the persona model 134b2 regarding the simulated opinions of a first group including the users of devices 136, 137, 138. The central server 134 may execute the persona model 134b2 to determine a response based on the prompt, and the response may include a recommended communication to the first group members to convey the relevant change data. Further, the central server 130 may also utilize the persona model 134b2 to generate a recommended stylistic scheme and/or a contextual scheme for a communication from the user to the first group members. Moreover, the server 104 may further utilize the persona model 134b2 to generate the recommended communication to the first group members that is articulated in accordance with the recommended stylistic scheme and/or the recommended contextual scheme.

The recommended stylistic scheme may represent how a user should convey the information (e.g., informally, high numbers of colloquialisms, short/long sentences), and the recommended contextual scheme may represent the subject matter of the conversation (e.g., software platform transition, organizational merger, office move) and the gravitas (or lack thereof) typically associated therewith. In certain embodiments, the recommended contextual scheme may also represent a predicted tone (e.g., happy, sad, angry, etc.) a user should use when communicating the information to the first group members. Regardless, the central server 134 may then transmit and/or otherwise cause the response to be displayed/conveyed for a user at the workstation 132 for interpretation by the user.

In certain embodiments, the persona model 134b2 may be trained to relate particular words/character strings to articulation styles and/or contextual inferences. For example, a character string comprising a simulated response may be: “I/we are very concerned about the proposed changes.”. This simulated response may indicate both that the group members are concerned/unhappy (e.g., due to the words “very concerned”), and that the group members may prefer communicating in shorter sentences (e.g., due to the relatively short, simulated sentence). Thus, the persona model 134b2 may provide a recommended communication and/or otherwise recommend communicating the change data to the group members in a relatively short response to mimic the group's preferred conversation style, and may recommend formatting/articulating the communication in a serious tone that expresses an appropriate level of consideration of the group's opinions (e.g., “We understand that this change may significantly impact your work, and remain committed to making this change as simple as possible.”).

In some embodiments, the central server 134 may include the group data 134b4 that may include user data (e.g., user data A 136b1, user data B 137b1, user data C 138b1) aggregated from multiple personnel that are members of a particular group. The user data may be extracted and/or otherwise received from individual devices (e.g., user device A 136, user device B 137, user device C 138), and may be stored in memory 134b1 at the central server 134. For example, the central server 134 may aggregate the user data and store the aggregated user data as the group data 134b4 by determining common, average, and/or otherwise uniform group characteristics represented in the aggregate user data from personnel of the particular group. For example, the user data, and by extension, the group data 134b4 may be or include respective communication preferences (e.g., stylistic preferences, communication methods (email, phone call), etc.), typical work schedules, typical responsibilities, typical task handle times, and the like for particular groups.

More generally, the group data 134b4 may be or include communications, documents, files, and/or any other suitable record or combinations thereof that include information corresponding to the group members. For example, the group data 134b4 may be or include an internal document, a received document, an archived email, a recorded verbal conversation, a recorded live chat, a video file, and/or a recorded text message.

The group data 134b4 may also correspond to communications between/among members within the computing system 130, external users, and/or any other users or combinations thereof. The internal/received document may be, for example, an internal best practices memo associated with a department corresponding to each member of the group, that details the common courses of action, responsibilities, duties, and/or other aspects or combinations thereof of the component 112. As another example, the internal/received document may be an archived email that was transmitted between/among group members within the computing system 130 that includes information associated with typical duties, responsibilities, preferences, and/or other suitable information corresponding to the group.

In certain embodiments, the central server 134 may include a response database 134b5 that stores prior/historical responses of the persona model 134b2. The persona model 134b2 may utilize the prior responses stored in the response database 134b5 to, for example, generate a response to a user query. The tracking model 134b3 may also utilize the prior responses stored in the response database 134b5 by comparing the prior responses with a current response output by the persona model 134b2 to generate a performance value of the persona model 134b2.

In some embodiments, the persona model 134b2 may receive a prompt, and in some embodiments, may extract/retrieve one or more embeddings from the prompt. The persona model 134b2 may then compare these embeddings to embeddings of prior responses in the response database 134b5 to identify prior responses that may have addressed a similar prompt, and the model 134b2 may generate a response based upon the identified prior responses.

In some embodiments, the central server 134 may also include change data 134b6 that may be used to create prompts for inputting into the persona model 134b2 and/or may be referenced by the persona model 134b2 when determining response(s) to the prompt. The change data 134b6 may generally be or include information related to a planned, on-going, and/or a completed organizational change/transformation, such as an organizational merger, a physical office space move, an entity structural reorganization, a software/hardware transition, and/or any other suitable large scale change. The change data 134b6 may include, for example, relevant names, dates, places, times, schedules, impacted personnel/groups, and/or any other suitable information or combinations thereof.

In order to execute these or other instructions stored in memory 134b, the central server 134 may communicate with a workstation 132. The workstation 132 may generally be any computing device that is communicatively coupled with the central server 134, and more particularly, may be a computing device with administrative permissions that enable a user accessing the workstation 132 to update and/or otherwise change data/models/applications that are stored in the memory 134b. For example, the workstation 132 may enable a user to access the central server 134, and the user may train the persona model 134b2 that is stored in the memory 134b. Additionally, or alternatively, the user may access the persona model 134b2 through the workstation 132 to provide prompts to the persona model 134b2 and receive responses from the persona model 134b2.

As discussed herein, in certain embodiments, the persona model 134b2 may be trained by and may implement machine learning techniques. In these embodiments, the user accessing the workstation 132 may upload training data, execute training sequences to train the persona model 134b2, and may update/re-train the persona model 134b2 over time. The workstation 132 may include one or more processors 132a, a networking interface 132c, a memory 132b, and a display 132d. The memory 132b may also include change data 132b1, that the workstation 132 may transmit to the central server 134 and/or utilize independently to train/re-train and/or prompt the persona model 134b2.

In some embodiments, the central server 134 may store and execute instructions that may generally train the persona model 134b2 and/or the tracking model 134b3 stored in the memory 134b. For example, the central server 134 may execute instructions included as part of the machine learning module 134b1 that are configured to train the persona model 134b2 to output responses to a prompts, recommended communications and/or communication styles, and/or any other values, responses, or combinations thereof. Additionally, the central server 134 may execute instructions included as part of the machine learning module 134b1 that are configured to train the tracking model 134b3 to generate performance values.

In particular, the training dataset(s) may include a plurality of training change data, a plurality of training change data portions, a plurality of group data, a plurality of training responses, a plurality of training performance values, and/or any other suitable data and combinations thereof. However, in certain embodiments, the persona model 134b2 and/or the tracking model 134b3 may be a rules-based algorithm configured to receive portions of change data (e.g., prompts), group data, responses, and/or other suitable data or combinations thereof as input and to output responses, communication recommendations, performance values, and/or other suitable values or combinations thereof as output.

In some embodiments, the persona model 134b2 and/or the tracking model 134b3 may be configured to utilize artificial intelligence and/or machine learning techniques. For instance, the persona model 134b2 and/or the tracking model 134b3 may be a ChatGPT chat bot. The persona model 134b2 and/or the tracking model 134b3 may employ supervised or unsupervised machine learning techniques, which may be followed or used in conjunction with reinforced or reinforcement learning techniques. The persona model 134b2 and/or the tracking model 134b3 may employ the techniques utilized for any suitable LLM, such as ChatGPT. The persona model 134b2 and/or the tracking model 134b3, may generate audible or verbal output, text or textual output, visual or graphical output, output for use with speakers and/or display screens, and/or other types of output for user and/or other computer or bot consumption.

Noted above, in some embodiments, the persona model 134b2 and/or the tracking model 134b3 or other computing device may be configured to implement machine learning, such that the persona model 134b2 and/or the tracking model 134b3 “learns” to analyze, organize, and/or process data without being explicitly programmed. Machine learning may be implemented through machine learning methods and algorithms. In one exemplary embodiment, the machine learning module 134b1 may be configured to implement machine learning methods and algorithms.

In some embodiments, at least one of a plurality of machine learning methods and algorithms may be applied, which may include but are not limited to: linear or logistic regression, instance-based algorithms, regularization algorithms, decision trees, Bayesian networks, naïve Bayes algorithms, cluster analysis, association rule learning, neural networks (e.g., convolutional neural networks, deep learning neural networks, combined learning module or program), deep learning, combined learning, reinforced learning, dimensionality reduction, support vector machines, k-nearest neighbor algorithms, random forest algorithms, gradient boosting algorithms, Bayesian program learning, voice recognition and synthesis algorithms, image or object recognition, optical character recognition, natural language understanding, and/or other ML programs/algorithms either individually or in combination. In various embodiments, the implemented machine learning methods and algorithms are directed toward at least one of a plurality of categorizations of machine learning, such as supervised learning, unsupervised learning, and reinforcement learning.

In one embodiment, the persona model 134b2 and/or the tracking model 134b3 employs supervised learning, which involves identifying patterns in existing data to make predictions about subsequently received data. Specifically, the persona model 134b2 and/or the tracking model 134b3 may be “trained” using training data, which includes example inputs and associated example outputs. Based upon the training data, the persona model 134b2 and/or the tracking model 134b3 may generate a predictive function which maps outputs to inputs and may utilize the predictive function to generate machine learning outputs based upon data inputs. The exemplary inputs and exemplary outputs of the training data may include any of the data inputs or machine learning outputs described above. In the exemplary embodiment, a processing element may be trained by providing it with a large sample of data with known characteristics or features.

In another embodiment, the persona model 134b2 and/or the tracking model 134b3 may employ unsupervised learning, which involves finding meaningful relationships in unorganized data. Unlike supervised learning, unsupervised learning does not involve user-initiated training based upon example inputs with associated outputs. Rather, in unsupervised learning, the persona model 134b2 and/or the tracking model 134b3 may organize unlabeled data according to a relationship determined by at least one machine learning method/algorithm employed by the persona model 134b2 and/or the tracking model 134b3. Unorganized data may include any combination of data inputs and/or machine learning outputs as described above.

In yet another embodiment, the persona model 134b2 and/or the tracking model 134b3 may employ reinforcement learning, which involves optimizing outputs based upon feedback from a reward signal. Specifically, the persona model 134b2 and/or the tracking model 134b3 may receive a user-defined reward signal definition, receive a data input, utilize a decision-making model to generate a machine learning output based upon the data input, receive a reward signal based upon the reward signal definition and the machine learning output, and alter the decision-making model so as to receive a stronger reward signal for subsequently generated machine learning outputs. Other types of machine learning may also be employed, including deep or combined learning techniques.

As an example, the persona model 134b2 and/or the tracking model 134b3 may employ natural language processing (NLP) functions, which generally involves understanding verbal/written communications and generating responses to such communications. The persona model 134b2 and/or the tracking model 134b3 may be trained to perform such NLP functionality using a symbolic method, machine learning models, and/or any other suitable training method. As an example, the persona model 134b2 and/or the tracking model 134b3 may be trained to perform at least two techniques that may enable the persona model 134b2 and/or the tracking model 134b3 to understand words spoken/written by a user: syntactic analysis and semantic analysis.

Syntactic analysis generally involves analyzing text using basic grammar rules to identify overall sentence structure, how specific words within sentences are organized, and how the words within sentences are related to one another. Syntactic analysis may include one or more sub-tasks, such as tokenization, part of speech (PoS) tagging, parsing, lemmatization and stemming, stop-word removal, and/or any other suitable sub-task or combinations thereof. For example, using syntactic analysis, the persona model 134b2 and/or the tracking model 134b3 may generate textual transcriptions from verbal responses from a user that are input to the persona model 134b2 and/or the tracking model 134b3 as a prompt.

Semantic analysis generally involves analyzing text to understand and/or otherwise capture the meaning of the text. In particular, the persona model 134b2 and/or the tracking model 134b3 applying semantic analysis may study the meaning of each individual word contained in a textual transcription in a process known as lexical semantics. Using these individual meanings, the persona model 134b2 and/or the tracking model 134b3 may then examine various combinations of words included in the sentences of the textual transcription to determine one or more contextual meanings of the words. Semantic analysis may include one or more sub-tasks, such as word sense disambiguation, relationship extraction, sentiment analysis, and/or any other suitable sub-tasks or combinations thereof. For example, using semantic analysis, the persona model 134b2 and/or the tracking model 134b3 may generate one or more intent interpretations based upon one or more textual transcriptions from a syntactic analysis.

After training, machine learning programs (or information generated by such machine learning programs) may be used to evaluate additional data. Such data may be and/or may be related to change data, group data, performance values, responses, and/or other data that was not included in the training dataset. The trained machine learning programs (or programs utilizing models, parameters, or other data produced through the training process) may accordingly be used for determining, assessing, analyzing, predicting, estimating, evaluating, or otherwise processing new data not included in the training dataset. Such trained machine learning programs may, therefore, be used to perform part or all of the analytical functions of the methods described elsewhere herein.

It is to be understood that supervised machine learning and/or unsupervised machine learning may also comprise retraining, relearning, or otherwise updating models with new, or different, information, which may include information received, ingested, generated, or otherwise used over time. Further, it should be appreciated that, as previously mentioned, the persona model 134b2 and/or the tracking model 134b3 may be used to output responses to prompts, communication recommendations, performance values, and/or any other values, responses, or combinations thereof using artificial intelligence (e.g., a machine learning model of the persona model 134b2 and/or the tracking model 134b3) or, in alternative aspects, without using artificial intelligence.

Moreover, although the methods described elsewhere herein may not directly mention machine learning techniques, such methods may be read to include such machine learning for any determination or processing of data that may be accomplished using such techniques. In some aspects, such machine learning techniques may be implemented automatically upon occurrence of certain events or upon certain conditions being met. In any event, use of machine learning techniques, as described herein, may begin with training a machine learning program, or such techniques may begin with a previously trained machine learning program.

In any event, the central server 134 may execute the persona model 134b2 to generate a response to a prompt, and the server 104 may then transmit the response to the workstation 132 for display to a user/operator. The user/operator may then review the response from the persona model 134b2 and may decide to initiate communications with one or more group members based on the information contained in the response. Moreover, in certain embodiments, the central server 134 may also initiate and/or transmit communication(s) between/among the workstation 132 and any relevant devices of impacted group members (e.g., user device A 136, user device B 137, user device C 138). In this manner, the user/operator may seamlessly begin communicating with the group member(s) and may optionally utilize the proposed/predicted communication(s) generated by the persona model 134b2 in response to the prompt.

Generally, the user devices 136, 137, 138 may be or include any device that is associated with (e.g., configured to connect with, etc.) a particular user (i.e., a group member), who may connect to and/or otherwise provide data that may be transmitted to the computing system 130 through the network 142. In certain embodiments, the user devices 136, 137, 138 may be a personal computing device of that user, such as a smartphone, a tablet, smart glasses, or any other suitable device or combination of devices (e.g., a smart watch plus a smartphone) with wireless communication capability. In the embodiment of FIG. 1B, the user devices 136, 137, 138 may each include a processor 136a, 137a, 138a; a memory 136b, 137b, 138b; a networking interface 136c, 137c, 138c; and an I/O interface 136d, 137d, 138d.

The user devices 136, 137, 138 may be communicatively coupled to the central server 134, the workstation 132, and/or the external server 140. For example, the user devices 136, 137, 138 and the central server 134, the workstation 132, and/or the external server 140 may communicate via USB, Bluetooth, Wi-Fi Direct, Near Field Communication (NFC), etc. For example, the central server 134 may transmit a recommended communication, and/or any other values, responses, or combinations thereof to the user devices 136, 137, 138 via the networking interfaces 134c, which the user devices 136, 137, 138 may receive via the networking interfaces 136c, 137c, 138c.

The external server 140 may be or include computing servers and/or combinations of multiple servers storing data that may be accessed/retrieved by the central server 134, the user devices 136, 137, 138, and/or the workstation 132. The data stored by the external server 140 may include a persona model 140b1 that is configured to generate similar outputs to the persona model 134b2. In certain embodiments, the external server 140 may receive data from the central server 134, the user devices 136, 137, 138, and/or the workstation 132, and may execute the persona model 140b1 to generate the outputs described herein. The external server 140 may include a processor 140a, a networking interface 140c, and a memory 140b that includes the persona model 140b1.

Each of the processors 132a, 134a, 136a, 137a, 138a, 140a may include any suitable number of processors and/or processor types. For example, the processors 132a, 134a, 136a, 137a, 138a, 140a may include one or more CPUs and one or more graphics processing units (GPUs). Generally, each of the processors 132a, 134a, 136a, 137a, 138a, 140a may be configured to execute software instructions stored in each of the corresponding memories 132b, 134b, 136b, 137b, 138b, 140b. The memories 132b, 134b, 136b, 137b, 138b, 140b may include one or more persistent memories (e.g., a hard drive and/or solid state memory) and may store one or more applications, modules, and/or models, such as the machine learning module 134b1, the persona model 134b2, and/or the tracking module 134b3.

The networking interface 134c may enable the central server 134 to communicate with the workstation 132, the user devices 136, 137, 138, the external server 140, and/or any other suitable devices or combinations thereof. More specifically, the networking interface 134c enables the central server 134 to communicate with each component of the exemplary computing system 130 across the network 142 through their respective networking interfaces 132c, 136c, 137c, 138c, 140c. The networking interface 134c may support wired or wireless communications, such as USB, Bluetooth, Wi-Fi Direct, Near Field Communication (NFC), etc. The networking interface 134c may enable the central server 134 to communicate with the various components of the exemplary computing system 130 via a wireless communication network such as a fifth-, fourth-, or third-generation cellular network (5G, 4G, or 3G, respectively), a Wi-Fi network (802.11 standards), a WiMAX network, a wide area network (WAN), a local area network (LAN), etc.

Moreover, the network 142 may be a single communication network, or may include multiple communication networks of one or more types (e.g., one or more wired and/or wireless personal or local area networks (PANs or LANs), and/or one or more wide area networks (WANs) such as the Internet). In some embodiments, the network 142 includes multiple, entirely distinct networks (e.g., one or more networks for communications between central server 134 and user device A 136, and a separate, Bluetooth or wireless LAN (WLAN) network for communications between central server 134 and workstation 132, and so on).

It will be understood that the above disclosure is one example and does not necessarily describe every possible embodiment. As such, it will be further understood that alternate embodiments may include fewer, alternate, and/or additional steps or elements.

### Exemplary Workflows for a Computing Device

FIG. 2A, depicts a first exemplary workflow 200 for data input/output of a computing device (e.g., the central server 134) of FIG. 1B, in accordance with various embodiments described herein. The first exemplary workflow 200 generally illustrates various data received/retrieved by the central server 134 that is utilized by the persona model 134b2 and/or the tracking model 134b3 as inputs to generate various outputs. The various data received/retrieved by the central server 134 includes portions of change data, group data, and/or response database entries. The outputs generated by the persona model 134b2 and/or the tracking model 134b3 based upon the received/retrieved data includes a response and/or tracking model feedback. As illustrated in FIG. 2A, the central server 134 includes a processor 134a, a memory 134b, a machine learning module 134b1, a persona model 134b2, a tracking model 134b3, and a networking interface 134c.

As previously described, the portions of change data, group data, and/or response database entries received/retrieved by the central server 134 may include a large variety of specific information/data. For example, the portion of the change data may be or include a prompt for interpretation/analysis by the persona model 134b2 that may be formulated based on the change data corresponding to an organizational change/transformation. Such change data may indicate, for example, that an organization is potentially merging with another organization, and the portion of change data submitted as a prompt to the persona model 134b2 requests feedback from a first group regarding this potential merger.

The portion of change data may be or include a verbal communication, a textual communication, and/or a visual communication. More specifically, the prompts indicated by the portions of change data may be or include textual data and/or other character strings that may indicate a question, series of questions, other prompt(s), verbal data indicating the prompt, image data corresponding to a prompt (e.g., proposed structural reorganization chart), and/or any other suitable information or combinations thereof. Of course, as referenced herein, the portion of change data may correspond to prompts submitted and/or otherwise input into the persona model 134b2 by/from a group member (e.g., using user device A 136), an administrative user/operator (e.g., via workstation 132), and/or from any other user(s) using any other suitable device(s) (e.g., external server 140) to access the central server 134.

As another example, the group data may be or include communications, documents, files, and/or any other suitable record or combinations thereof that include information corresponding to the group members. The group data may also be or include a text string, an internal document, a received document, an archived email, a recorded file, a live audio stream, recorded verbal conversation, a recorded live chat, a live video call, a recorded video file, and/or a recorded text message. In certain embodiments, the group data may include questionnaire documents related to prior feedback requests from group members, best practices documents for a particular group, internal communications between workstations (e.g., workstation 132) describing answers to particular issues related to a frequent task of the group, a plurality of documentation corresponding to conversation topics (e.g., underlying tasks, responsibilities, sentiments) of the group members, and/or any other suitable data or combinations thereof.

The response database entries may be or include prior/historical responses of the persona model 134b2. For example, the persona model 134b2 may receive a prompt, and in some embodiments, may extract/retrieve one or more embeddings from the prompt. The persona model 134b2 may then compare these embeddings to embeddings of the response database entries to identify prior responses that may have addressed a similar prompt, and may generate the response based, in part, on the response database entries.

Of course, in certain instances, the central server 134 may not receive group data, response database entries, and/or tracking model feedback. In these instances, the central server 134 may receive only the portion of change data and may proceed to generate a response, train/re-train the persona model 134b2, and/or otherwise utilize the portion of change data to perform an action with respect to the persona model 134b2 and/or the tracking model 134b3. For example, the portion of change data may represent a prompt from a user corresponding to a hypothetical change to test, train, and/or re-train the persona model 134b2. The central server 134 may execute the persona model 134b2 to generate a training response based on the portion of change data, and may proceed to evaluate the training response to update/train/re-train the persona model 134b2 using instructions stored as part of the machine learning module 134bl.

Regardless, prior to the central server 134 may utilizing the persona model 134b2 and/or the tracking model 134b3 to output responses and/or tracking model feedback (e.g., performance values), the central server 134 may execute instructions included as part of the machine learning module 134b1 to train the models 134b2, 134b3. This training process may include aggregating a plurality of group data. This group data, as mentioned, may include: (i) an internal document, (ii) an archived email, (iii) a recorded verbal conversation, (iv) a recorded live chat, and/or any other suitable records that may indicate rules, opinions, preferences, and/or other information pertaining to a particular group. The central server 134 may also aggregate a plurality of training change data. This training change data may include prior change data corresponding to prior organizational changes that may have resulted in successful adoption, ongoing adoption, and/or failed adoption of the respective change(s) across one or multiple groups. To train the tracking model 134b3, the central server 134 may also aggregate prior/training responses from the persona model 134b2, prior/training performance values, and/or any other suitable values or data described herein or combinations thereof.

With the aggregated data, the central server 134 may proceed with training the persona model 134b2 and/or the tracking model 134b3 by executing instructions included as part of the machine learning module 134bl. The processors 134a may, for example, execute the instructions stored on in the machine learning module 134b1 to train the persona model 134b2 with the plurality of training change data and the plurality of group data as inputs to generate a plurality of training responses as outputs. The processors 134a may then evaluate the plurality of training responses to determine whether the training responses accurately reflect the predicted and/or known aggregate opinions, thoughts, concerns, and/or other aspects of the group members the persona model 134b2 is intended to represent. For example, if the persona model 134b2 outputs a training response indicating that the group collectively is excited for a first change, but the known response of the first group members was universal revilement for the first change, then the processors 134a may determine that the persona model 134b2 requires further training to more accurately reflect the intended group.

Similarly, the processors 134a may execute the instructions stored on in the machine learning module 134b1 to train the tracking model 134b3 with the plurality of training change data portions, a plurality of training responses, and a plurality of training performance values as inputs to generate a plurality of training performance values and/or a plurality of training recommended adjustments as outputs. The processors 134a may evaluate the plurality of training performance values and/or the plurality of training recommended adjustments to determine whether the training performance values accurately reflect the predicted and/or known ability of the persona model 134b2 to generate responses representative of the intended group and/or whether the training recommended adjustments accurately indicate the predicted and/or known adjustments made to a persona model 134b2 (e.g., weighting/parameter adjustments, etc.) that improved subsequent performance. For example, if the tracking model 134b3 outputs a training performance value indicating that the persona model 134b2 generated a highly accurate response, but the response is known to have been inaccurate and/or otherwise erroneous, then the processors 134a may determine that the tracking model 134b3 requires further training to more accurately indicate the performance of the persona model 134b2.

Once the persona model 134b2 and/or the tracking model 134b3 is/are trained, the central server 134 may actively implement the persona model 134b2 by receiving change data associated with an organizational change anticipated to affect members of the group for which the persona model 134b2 is intended to represent. The central server 134 may input a portion of the change data into the persona model 134b2 configured to generate responses representative of the group, and the persona model 134b2 may generate a response to the portion of the change data. The central server 134 may also proceed to output the response for display to a user. In certain embodiments, the response may include: (i) a predicted subsequent response strategy to address the intended group, (ii) a change receptiveness likelihood value, (iii) a predicted uptake time value, (iv) a best practices indication, (v) a successful adoption likelihood value, (vi) an estimated timeline for adoption, (vii) a realization value, and/or any other suitable values or combinations thereof. For example, and as discussed herein, the response may indicate how long it may take the group to adopt the change indicated by the portion of change data and/or how long it may take the group to collectively reach certain milestones/progress markers during the overall process of transformation adoption.

In some embodiments, the central server 134 may extract the portion of the change data from change data received at the central server 134. The central server 134 may also create, for example, a formatted input that includes a plurality of prompts for the persona model 134b2 based on the portion of the change data, and may input the formatted input into the persona model 134b2 as part of the portion of the change data. As an example, the central server 134 may receive change data indicating a first organizational change that may occur and/or begin occurring six months from the current date. The processors 134a may extract certain keywords and/or other relevant information from this received change data, such as a type or characterization of the change, a potential date/time of the change, affected groups, and/or any other suitable information, and may generate the formatted input using this portion of the change data. These formatting and auto-generation instructions may be stored in memory 134b and may cause the processors 134a to generate a structured/standardized prompt and/or set of prompts (e.g., questions) based on the extracted portion of the change data to serve as inputs to the persona model 134b2. Thus, the persona model 134b2 may analyze the prompt/set of prompts and provide responses to each question or statement included therein. As a result, the processors 134a may streamline the input generation and output sequence to/from the persona model 134b2 by executing the data extraction and format standardization process for received change data described herein.

In some embodiments of a prompt input and response generation sequence, the central server 134 may receive a first verbal communication of the portion of the change data. In other words, in this example, the portion of the change data may be received at the central server 134 in the form of a verbal communication from a user. The central server 134 may convert the first verbal communication to a first text string representing the portion of the change data and may generate, by executing the persona model 134b2, the response to the portion of the change data as a second text string. The central server 134 may then convert the second text string to a second verbal communication and cause the second verbal communication to be conveyed to the user. Thus, in this example, the processors 134a may intake, parse, analyze, and respond to the user's verbal communication automatically using the instructions stored in memory 134b, such as the persona model 134b2. This functionality may introduce additional efficiencies over conventional techniques derived from not requiring users to painstakingly format, type, and/or otherwise generate written inputs, but instead allowing the users to verbally request responses quickly and easily from the persona model 134b2.

The central server 134 may also receive updated change data associated with the organizational change that may indicate progress updates, status changes, and/or other new information corresponding to the organizational change. When receiving this updated change data, the central server 134 may also receive, extract, and/or otherwise input a portion of the updated change data into the persona model 134b2. The persona model 134b2 may then generate an updated response to the portion of the updated change data, and the updated response may represent an updated outlook of the intended group with respect to the organizational change. For example, the initial response generated by the persona model 134b2 may have indicated that the intended group would adopt the change quickly and had a generally positive outlook toward the proposed change. However, as the change has been implemented, the opinions of the group members may have become less positive, such that the updated response to the portion of the updated change data may accordingly reflect a less positive outlook towards the change and/or a less favorable adoption forecast for the intended group relative to the initial response. The central server 134 may then also output and/or cause the updated response to be displayed to the user.

This continual, periodic, and/or otherwise on-going response updating sequence may enable users to leverage the persona model 134b2 and/or the tracking model 134b3 throughout the transformation adoption process to better understand how the transformation is progressing relative to conventional techniques. Namely, the periodic updated response generation performed by the persona model 134b2 in response to the receipt of updated change data may allow users to better appreciate how individual groups understand the change, are adopting the change, have confidence and competence regarding various aspects of the change, are building new habits and rituals in view of the change, and/or are otherwise adapting to the change over time in a manner that was simply unachievable using conventional techniques.

For example, a first set of change data may indicate a proposed merger between a first organization and a second organization and the persona model 134b2 may be trained to reflect the aggregate opinions of a first group at the first organization. The change data may further indicate that the proposed merger may involve the consolidation of personnel between the first and second organization, merging and/or overhauling of software platforms and/or records between the first and second organization, and a change in work location. Initially, the persona model 134b2 may receive the change data and/or a portion of the change data representing the proposed merger and may output a response indicating that the first group will likely be able to adopt the transformation well because the group members probably view this change as non-threatening and a welcome update to outdated software/records and/or an improvement to the work location.

However, continuing the prior example, the central server 134 may later receive updated change data indicating that the proposed merger has expanded to include a third organization that may result in different personnel consolidation, different software/records changing/overhauling, and/or a different work location. The persona model 134b2 may receive this updated change data and/or a portion of this updated change data representing the expanded proposed merger, and may output a response indicating that the first group is far less likely to adopt this transformation well. The group members may likely view this proposed merger more negatively than the prior proposed merger because the consolidation of personnel from three organizations may lead to significant layoffs, software/records merging or overhauling may become more complicated and time-consuming, and/or the different work location is further away from many of the group member's residential areas as compared to the prior work location. Thus, as additional change data updates are received by the central server 134, the persona model 134b2 may continue to provide updated insights regarding the progress and/or thoughts/opinions of the group members.

Additionally, as the persona model 134b2 continues to provide responses reflecting the progress and/or thoughts/opinions of the group members, the central server 134 may also execute the tracking model 134b3 to track the performance of the persona model 134b2. The central server 134 may, for example, input the portion of the change data and the response to the portion of the change data into the tracking model 134b3 to generate performance values representative of an ability of the persona model 134b2 to generate responses representative of the intended group.

The tracking model 134b3 may generate a performance value corresponding to the response generated by the persona model 134b2. As mentioned, the performance value may be representative of an ability of the persona model 134b2 to generate responses representative of the intended group (e.g., provides outputs representing the opinions, thoughts, and/or concerns of the intended group), the performance value may also include, reference, and/or otherwise encapsulate the potential areas of improvement for the persona model 134b2, and/or the performance value may represent a degree to which the persona model 134b2 provides impactful, effective recommendations in response to certain inputs, and/or provides any other suitable outputs or combinations thereof. The tracking model 134b3 may then compare the performance value with a prior performance value to track the performance of the persona model and may generate a recommended adjustment to the persona model based on the comparing.

For example, the persona model 134b2 may output a response indicating that a first group is progressing well in adopting a first transformation and will likely fully adopt the transformation in the next three months. Ultimately, the central server 134 may receive updated group data, updated change data, and/or other data indicating that the response inaccurately reflected the actual progression and/or progression capability of the intended group and/or that the predicted three month timeline for full adoption was incorrect. The tracking model 134b3 may receive this updated data and may analyze a degree to which the response was inaccurate (e.g., four months for actual full adoption v. ten months for actual full adoption) to generate a performance value and/or recommended adjustments to the persona model 134b2. The performance value may be relatively low in this example, and the recommended adjustments may include various weighting/parametric adjustments to the persona model 134b2 based on the types and degrees of inaccuracies present in the response.

Moreover, the recommended adjustments may be determined in a variety of manners. For example, the tracking model 134b3 may compare the performance value with a prior performance value corresponding to track and/or otherwise evaluate the performance of the persona model 134b2 to simulate the intended group over time and/or the model 134b3 may compare the performance value with a threshold value, below which, the model 134b3 may determine that the persona model 134b2 may require adjustments. In other words, the tracking model 134b3 determining that the performance value is lower than one or more prior performance values may indicate that the persona model 134b2 is falling out of touch with the group over time and needs to be generally re-trained/adjusted to bring the model 134b2 back in line with the current group sentiment. The tracking model 134b3 determining that the performance value is below and/or otherwise fails to satisfy a threshold value may indicate that the persona model 134b2 is not currently trained to accurately/effectively predict group sentiment and/or other values when certain change data, group data, and/or other input data is involved. Thus, the recommended adjustment in these instances may include more acute training to enhance/improve the persona model's 134b2 ability to accurately/efficiently model opinions, thoughts, characteristics, and/or other aspects of the intended group regarding the specific data used as input that resulted in the generation of the inaccurate response.

In certain embodiments, the persona model 134b2 may include a plurality of persona models. In these embodiments, each persona model 134b2 of the plurality of persona models may be configured to generate responses representative of a respective subset of the intended group, and each respective subset of the intended group may represent a different perspective with respect to the organizational change from every other respective subset of the intended group. For example, the central server 134 may execute instructions included as part of the machine learning module 134b1 to generate a set of persona models 134b2 for each group within an organization, and the set of persona models 134b2 may include at least one model for each of a pre-determined set of perspectives. These perspectives may be generally labelled as the “supporter,” the “cynic”, the “champion”, and/or the “adversary”, and each group may have a trained persona model 134b2 to represent the thoughts, opinions, characteristics, and/or other aspects of group members that may interpret and/or otherwise react to an organizational change by adopting one or more of these perspectives. Of course, the perspectives described herein are for the purposes of discussion only, and it should be appreciated that the persona model 134b2 may include any suitable number of persona models 134b2 that reflect any suitable number and/or type of perspective(s).

These different perspectives may each possess characteristics that may, when taken together, reflect a complete range of perspectives that members of any group may have when considering a particular change. Namely, the “champion” may provide active, visible, vocal support for a change or transformation, and/or may possess some degree of positional, expert, or social authority to positively impact the change. The “supporter” may passively support and welcome the change and may not or may not be able to take a leadership role or may need champions and/or change managers to help them along. The “cynics” may be suspicious of the change and may often provide feedback of a type or quality similar to “this didn't work last time we tried it, but we'll see what happens.” Cynics may not actively support the change, but also may not actively attempt to derail the adoption efforts of the group or organization. The “adversaries” may actively, visibly, and/or vocally attempt to delay or stop a change or transformation. Adversaries may have valid reasons but may typically be found to hinder the organization's ability to progress through change/transformation adoption as originally anticipated.

To illustrate, a first organization may broadly have three groups of personnel: a first group, a second group, and a third group. The group members for each of these three groups may have a wide variety of thoughts, opinions, characteristics, temperaments, and/or other qualities/aspects that can lead to a similarly wide variety of perceptions of a proposed/on-going/completed organizational change. Nevertheless, the central server 134 may execute instructions included as part of the machine learning module 134b1 to train four persona models 134b2 for the first group, four persona models 134b2 for the second group, and four persona models 134b2 for the third group. Each of these persona models 134b2 for each group may be trained to simulate the responses that may be provided by group members of the respective groups that are fulfilling and/or engaging in a manner consistent with one of the perspectives outlined above. Using the responses from these four distinct persona models 134b2, the central server 134 may also determine an aggregate response from each group that reflects the relative strength and/or other characteristics of the responses output by each individual persona model 134b2. In this manner, the central server 134 and the persona models 134b2 may provide a more holistic prediction of the responses various groups may have to a particular transformation than conventional techniques by allowing the individual persona models 134b2 to provide responses/arguments from forced perspectives that the actual group members may not adopt or consider when presented with the proposed/on-going/completed transformation.

Further in these embodiments, each persona model 134b2 of the plurality of persona models 134b2 may be trained using the plurality of change data and a plurality of subset group data as inputs to output a respective plurality of training responses. The central server 134 may then utilize these persona models 134b2 by inputting a portion of the change data into the plurality of persona models 134b2, causing the plurality of persona models 134b2 to generate a plurality of responses to the portion of the change data, and causing the plurality of persona models 134b2 to output the plurality of responses for display to the user.

Practically speaking, the persona model(s) 134b2 may output the response with a set of classification values and/or classifications that have associated confidence value(s)/interval(s). For example, the response may include a confidence value of 80% indicating that the intended group has an 80% likelihood of successful transformation adoption on the anticipated timeline. Of course, the response may be or include such confidence value(s)/interval(s) in any suitable representation, such as a single numerical value (e.g., 1, 2, 3, etc.), a confidence interval, a percentage (e.g., 95%, 50%, etc.), an alphanumerical character(s) (e.g., A, B, C, etc.), a symbol, and/or any other suitable value or indication of a likelihood corresponding to the intended group.

In some embodiments, the persona model 134b2 may output the response as a set or list of classification values corresponding to the likely outcome(s) for a particular transformation with respect to the intended group. For example, the persona model 134b2 may output a response with a first transformation adoption scenario for the intended group with a confidence value of 95%, a second transformation adoption scenario for the intended group with a confidence value of 75%, and a third transformation adoption scenario for the intended group with a confidence value of 45%.

FIG. 2B, depicts a second exemplary workflow 220 for data input/output of a computing device (e.g., the central server 134) of FIG. 1B, in accordance with various embodiments described herein. In particular, the second exemplary workflow 220 broadly illustrates an example response generation sequence, in which the persona model 134b2 may receive a portion of change data and/or group data as inputs, determine/extract embeddings from the inputs, compare those embeddings to an embedding dictionary 226 and/or response database entries from the response database 134b5, and generate the response. Of course, this response generation sequence illustrated in FIG. 2B is for the purposes of discussion only, and additional/alternative response generation sequences utilizing additional/alternative machine learning techniques may also be utilized.

At a first time instance 222, the persona model 134b2 may receive a portion of change data and/or group data, as described herein. Both the portion of change data and/or group data may typically include a character string and/or a data sequence that may be converted to a text/character string representing data for processing by the persona model 134b2. For example, the portion of change data may include data from an external device (e.g., workstation 132) that is provided by a user in the form of a question or other prompt corresponding to an organizational change. Additionally, or alternatively, the portion of change data and/or group data may include written/transcribed natural language from a user/operator. This natural language included in the portion of change data and/or group data may also, for example, represent data related to/taken from the response database entries, and/or other input(s) that may influence the resulting response output by the persona model 134b2.

When the persona model 134b2 receives the portion of change data and/or group data, the persona model 134b2 may then proceed to interpret the portion of change data and/or group data in a manner consistent with the machine learning techniques used to train the persona model 134b2, as discussed herein. As illustrated in FIG. 2B, one such interpretation may be to segment the portion of change data and/or group data into various character strings that have corresponding embeddings. Individual words, data sequences, and/or other character sets may have or receive particular embeddings that represent an n-dimensional value, where each coordinate value or “item” of the embedding may be associated with a particular characteristic of the character set, and n may be any suitable integer value. For example, embedding A may be an n-dimensional value corresponding to a first character set in the portion of change data and/or group data, embedding B may be an n-dimensional value corresponding to a second character set in the portion of change data and/or group data, and embedding N may be an n-dimensional value corresponding to a last character set in the portion of change data and/or group data. In any event, the persona model 134b2 may generate a set of embeddings for some/all of the data included as part of the portion of change data and/or group data.

At a second time instance 224, the persona model 134b2 may compare each of the embeddings to an embedding dictionary 226 to determine associations between the portion of change data and/or group data and similar portions of change data and/or group data, and by proxy, corresponding responses associated with those similar portions of change data and/or group data. More specifically, the persona model 134b2 may reference the embeddings stored in the embedding dictionary 226 to determine embeddings that are “close” to the embeddings of the portion of change data and/or group data. This measure of closeness may be determined by calculating, for example, a geometric distance between two embeddings within the corresponding n-dimensional space. Each embedding may be compared to the embeddings in the embedding dictionary 226 in this manner, and the persona model 134b2 may determine one or more embeddings from the dictionary 226 that are the closest to the embeddings from the portion of change data and/or group data.

In certain embodiments, the embeddings in the embedding dictionary 226 may be associated with prior portions of change data, prior group data, and/or prior responses, such as those stored in the response database 134b5. Namely, the embedding dictionary 226 may include and/or reference a storage location where the associated prior portions of change data, prior group data, and/or prior responses are stored to enable the persona model 134b2 to reference and/or otherwise utilize these prior portions of change data, prior group data, and/or prior responses when generating a new response based upon an input portion of change data and/or group data. The persona model 134b2 may thereby determine that embeddings from a portion of change data and/or group data that are relatively close (in the n-dimensional space) to a first set of embeddings in the embedding dictionary 226 may be associated with a similar portion of change data, group data, response, and/or other data or combinations thereof.

Consequently, the persona model 134b2 may generate a response based upon the comparison of the embeddings from the portion of change data and/or group data to the embedding dictionary 226. For example, the persona model 134b2 may determine that the embeddings from the portion of change data and/or group data are relatively close (in the n-dimensional space) to embeddings in the embedding dictionary 226 that are associated with a first response. The persona model 134b2 may then access prior portions of change data, prior group data, and/or prior responses corresponding to the first response to determine a response that most accurately reflects the circumstances indicated in the portion of change data and the group data.

### Exemplary Graphical User Interfaces (GUIS)

FIG. 3 depicts an exemplary graphical user interface (GUI) 300 that may be displayed on a computing device (e.g., workstation 132 of FIG. 1), in accordance with various embodiments described herein. Generally, the exemplary GUI 300 may allow a user (e.g., an administrative user/operator) to interact with the central server 134, which may include receiving outputs from the central server 134 or sending inputs to the central server 134, as described in reference to the first exemplary workflow 200 of FIG. 2A. The exemplary GUI 300 thus provides the user with a designated place to remain informed regarding the functioning of a computing system configured to establish, maintain, and perform simulation activities between/among various devices (e.g., central server 134, workstation 132, user devices 136, 137, 138). In particular, the exemplary GUI 300 may display information, values, maps, contact information, and/or other data related to change data, group data, and/or responses corresponding to and/or otherwise associated with groups that may experience impacts from an organizational change.

Namely, the exemplary GUI 300 may include a change data hub 312, a predicted response hub 318, and a recommendation hub 320. The change data hub 312 may include a predicted adoption completion indication 313, a predicted adoption completion value 314, a group data access button 315, and a performance value access button 316. The user may directly interact (e.g., click, swipe, tap, gesture, voice command, etc.) with the group data access button 315 and/or the performance value access button 316 to initiate additional actions that may direct the user away from the exemplary GUI 300.

For example, interacting with the group data access button 315 may cause the workstation 132 to load and render and/or otherwise cause the user to view one or more documents, files, communications, and/or any other suitable data or combinations thereof related to the corresponding group(s) indicated in the portion of change data analyzed by the persona model 134b2. The user may view the group data on the workstation 132 (or user device A 136) display, and in certain embodiments, the relevant portions of the group data may be highlighted and/or otherwise marked for specific reference by the user. In this manner, the user may direct their attention to the relevant portions of the group data that may have influenced the response(s) provided in the predicted response hub 318. The user may read the group data and may independently validate the information provided in the response and/or otherwise check that the persona model 134b2 is accessing/referencing relevant information when generating responses for a particular group(s), about which, a user may provide a portion of change data.

Interacting with the performance value access button 316 may cause the workstation 132 to load and render and/or otherwise cause the user to view one or more performance values and/or recommended actions related to the performance of the persona model 134b2. The user may view the performance value(s) and/or recommendations on the workstation 132 (or user device A 136) display, and in certain embodiments, the relevant portions of the performance value(s) and/or recommendations may be highlighted and/or otherwise marked for specific reference by the user. In this manner, the user may direct their attention to the relevant portions of the performance value(s) and/or recommendations that may influence any subsequent training-re/training of the persona model 134b2.

The predicted adoption completion indication 313 and the predicted adoption completion value 314 may generally correspond to an estimated time required for the group to completely adopt the change indicated in the portion of change data input to the persona model 134b2. In this manner, a user may view the predicted adoption completion value 314 and understand approximately how long the transformation adoption may take for a particular group and/or for the entire organization. In certain embodiments, the predicted adoption completion value 314 may be based upon prior transformation adoption times for identical/similar change data.

Generally speaking, the predicted response hub 318 and the recommendation hub 320 may provide instructions, values, recommendations, and/or other indications to a user related to data processed by the central server 134. For example, as illustrated in FIG. 3, the predicted response hub 318 provides: “Portion of Change Data: ‘How would changing software platforms from A to B impact your workflow?’,” “Predicted Response from Group A: ‘We are relatively indifferent to changing from platform A to B because most, if not all, of our work currently takes place outside of platform A.’,” “Predicted Response from Group B: ‘We are hesitant to change from platform A to B because most of our attendant platforms are deeply integrated with platform A. Changing would thereby require substantial reconfiguration and some measure of downtime of the platform and attendant software.’,” “Predicted Response from Group N: ‘We are in favor of transitioning from platform A to platform B. Platform A is typically slow and buggy, so platform B would very likely be an improvement over platform A.’.” The user may view the predicted response(s) in the predicted response hub 318, and the user may evaluate how to proceed communicating and/or otherwise interacting with the various groups represented therein to address the organizational change indicated in the portion of change data.

As yet another example, and as illustrated in FIG. 3, the recommendation hub 320 states that “[b]ased on the input portions of change data, the proposed change from platform A to B would likely minimally impact the members of Group A, frustrate members of Group B, and would satisfy the members of Group N.” “It is therefore recommended to convey the proposed transformation to members of group A and N in any suitable manner.” “It is also recommended to convey the proposed transformation to members of group B in a similar manner to: ‘We will be transitioning from platform A to B beginning on date X. We realize that such a transition will take time and may impact your daily workflow. However, we intend to take steps necessary to ensure your day-to-day work is not impeded and that this transition is as smooth as possible to help everyone have an improved experience.’.” The persona model 134b2 may generate such a recommended communication strategy and/or language summary to quickly educate a user regarding the key takeaways from the persona model 134b2 analysis as well as provide the user with recommended language to approach one or more groups. The user may also view the recommended communication strategy and/or language summary in the recommendation hub 320, and the user may evaluate how accurately the persona model 134b2 has analyzed/interpreted and/or otherwise responded as an aggregate group member of any/all groups represented in the persona model 134b2 outputs. In this manner, the user may further determine whether the persona model 134b2 should be updated/re-trained, and/or whether the user should use and/or rely on the information provided in the recommended communication strategy and/or language summary displayed in the recommendation hub 320.

Moreover, it should be understood that any change data, group data, and/or any values determined, detected, calculated, and/or otherwise output by the central server 134 may be displayed generally in the exemplary GUI 300. Additionally, or alternatively, it should be appreciated that interaction with any of the hubs or other displays in the exemplary GUI 300 may cause the workstation 132, the user devices 136, 137, 138, and/or the central server 134 to perform other actions than those described in reference to FIG. 3. As such, other actions/signals described herein may be transmitted, relayed, and/or otherwise performed by the workstation 132, user devices 136, 137, 138, and/or the central server 134 in response to a user interacting with any hub or display within the exemplary GUI 300.

### Exemplary Computer-Implemented Methods

FIG. 4 depicts a flow diagram representing an exemplary computer-implemented method 400, in accordance with various embodiments described herein. The method 400 may be implemented by one or more processors of the exemplary computing system 130, such as the central server 134, the workstation 132, the user devices 136, 137, 138, the external server 140, and/or any other suitable components described herein or combinations thereof.

The method 400 may include receiving change data associated with an organizational change anticipated to affect members of a first group (block 402). The method 400 may further include inputting a portion of the change data into a persona model configured to generate responses representative of the first group (block 404). The persona model may be trained using a plurality of training change data and a plurality of group data as inputs to output a plurality of training responses. The method 400 may further include generating, by executing the persona model, a response to the portion of the change data (block 406). The method 400 may further include outputting the response for display to a user (block 408).

In certain embodiments, the method 400 may further include inputting the portion of the change data and the response to the portion of the change data into a tracking model configured to generate performance values representative of an ability of the persona model to generate responses representative of the first group (block 410). In these embodiments, the tracking model may be trained using a plurality of training change data portions, a plurality of training responses, and a plurality of training performance values as inputs to output a plurality of training performance values and a plurality of training recommended adjustments. Further, the method 400 may include generating, by executing the tracking model, a performance value corresponding to the response generated by the persona model (block 412). The method 400 may further include comparing, by executing the tracking model, the performance value with a prior performance value to track the performance of the persona model (block 414). The method 400 may further include generating, by executing the tracking model, a recommended adjustment to the persona model based on the comparing (block 416).

In some embodiments, the method 400 may further include: receiving, at the one or more processors, updated change data associated with the organizational change; inputting, by the one or more processors, a portion of the updated change data into the persona model; generating, by the one or more processors executing the persona model, an updated response to the portion of the updated change data, wherein the updated response may represent an updated outlook of the first group with respect to the organizational change; and outputting, by the one or more processors, the updated response for display to the user.

In certain embodiments, the method 400 may further include: aggregating, by the one or more processors, the plurality of group data that includes one or more of: (i) an internal document, (ii) an archived email, (iii) a recorded verbal conversation, or (iv) a recorded live chat; aggregating, by the one or more processors, the plurality of training change data; and training, by the one or more processors executing a training module, the persona model with the plurality of training change data and the plurality of group data as inputs to generate the plurality of training responses as outputs.

In some embodiments, the persona model may include a plurality of persona models; each persona model of the plurality of persona models may be configured to generate responses representative of a respective subset of the first group, each respective subset of the first group representing a different perspective with respect to the organizational change from every other respective subset of the first group; each persona model of the plurality of persona models may be trained using the plurality of change data and a plurality of subset group data as inputs to output a respective plurality of training responses; and the method 400 may further include: inputting, by the one or more processors, the portion of the change data into the plurality of persona models, generating, by the one or more processors executing the plurality of trained persona models, a plurality of responses to the portion of the change data, and outputting, by the one or more processors, the plurality of responses for display to the user.

In certain embodiments, the response may include at least one of: (i) a predicted subsequent response strategy to address the first group, (ii) a change receptiveness likelihood value, (iii) a predicted uptake time value, (iv) a best practices indication, (v) a successful adoption likelihood value, (vi) an estimated timeline for adoption, or (vii) a realization value.

In some embodiments, the method 400 may further include: extracting, by the one or more processors, the portion of the change data from the change data; creating, by the one or more processors, a formatted input that includes a plurality of prompts for the persona model based on the portion of the change data; and inputting, by the one or more processors, the formatted input into the persona model as part of the portion of the change data.

In certain embodiments, the method 400 may further include: receiving, at the one or more processors, a first verbal communication of the portion of the change data; converting, by the one or more processors, the first verbal communication to a first text string representing the portion of the change data; generating, by the one or more processors executing the persona model, the response to the portion of the change data as a second text string; converting, by the one or more processors, the second text string to a second verbal communication; and causing, by the one or more processors, the second verbal communication to be conveyed to the user.

Of course, it is to be appreciated that the actions of the method 400 may be performed any suitable number of times, and that the actions described in reference to the method 400 may be performed in any suitable order.

### ADDITIONAL CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

The systems and methods described herein are directed to an improvement to computer functionality, and improve the functioning of conventional computers. Additionally, certain embodiments are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, and/or may be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

It should also be understood that, unless a term is expressly defined in this patent using the sentence “As used herein, the term ‘ ’ is hereby defined to mean . . . ” or a similar sentence, there is no intent to limit the meaning of that term, either expressly or by implication, beyond its plain or ordinary meaning, and such term should not be interpreted to be limited in scope based upon any statement made in any section of this patent (other than the language of the claims). To the extent that any term recited in the claims at the end of this disclosure is referred to in this disclosure in a manner consistent with a single meaning, that is done for sake of clarity only so as to not confuse the reader, and it is not intended that such claim term be limited, by implication or otherwise, to that single meaning.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still cooperate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible embodiment, as describing every possible embodiment would be impractical, if not impossible. One could implement numerous alternate embodiments, using either current technology or technology developed after the filing date of this application.

Upon reading this disclosure, those of skill in the art will appreciate still additional alternative structural and functional designs for evaluation properties, through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s). The systems and methods described herein are directed to an improvement to computer functionality, and improve the functioning of conventional computers.

What is claimed is:

1. A computer-implemented method for simulating transformation adoption, the method comprising:
receiving, at one or more processors, change data associated with an organizational change anticipated to affect members of a first group;
inputting, by the one or more processors, a portion of the change data into a persona model configured to generate responses representative of the first group, wherein the persona model is trained using a plurality of training change data and a plurality of group data as inputs to output a plurality of training responses;
generating, by the one or more processors executing the persona model, a response to the portion of the change data; and
outputting, by the one or more processors, the response for display to a user.

2. The computer-implemented method of claim 1, further comprising:
inputting, by the one or more processors, the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments;
generating, by the one or more processors executing the tracking model, a performance value corresponding to the response generated by the persona model;
comparing, by the one or more processors executing the tracking model, the performance value with a prior performance value to track the performance of the persona model; and
generating, by the one or more processors executing the tracking model, a recommended adjustment to the persona model based on the comparing.

3. The computer-implemented method of claim 1, further comprising:
receiving, at the one or more processors, updated change data associated with the organizational change;
inputting, by the one or more processors, a portion of the updated change data into the persona model;
generating, by the one or more processors executing the persona model, an updated response to the portion of the updated change data, wherein the updated response represents an updated outlook of the first group with respect to the organizational change; and
outputting, by the one or more processors, the updated response for display to the user.

4. The computer-implemented method of claim 1, further comprising:
aggregating, by the one or more processors, the plurality of group data that includes one or more of: (i) an internal document, (ii) an archived email, (iii) a recorded verbal conversation, or (iv) a recorded live chat;
aggregating, by the one or more processors, the plurality of training change data; and
training, by the one or more processors executing a training module, the persona model with the plurality of training change data and the plurality of group data as inputs to generate the plurality of training responses as outputs.

5. The computer-implemented method of claim 1, wherein:
the persona model includes a plurality of persona models;
each persona model of the plurality of persona models is configured to generate responses representative of a respective subset of the first group, each respective subset of the first group representing a different perspective with respect to the organizational change from every other respective subset of the first group;
each persona model of the plurality of persona models is trained using the plurality of change data and a plurality of subset group data as inputs to output a respective plurality of training responses; and
the method further comprises:
inputting, by the one or more processors, the portion of the change data into the plurality of persona models,
generating, by the one or more processors executing the plurality of trained persona models, a plurality of responses to the portion of the change data, and
outputting, by the one or more processors, the plurality of responses for display to the user.

6. The computer-implemented method of claim 1, wherein the response includes at least one of: (i) a predicted subsequent response strategy to address the first group, (ii) a change receptiveness likelihood value, (iii) a predicted uptake time value, (iv) a best practices indication, (v) a successful adoption likelihood value, (vi) an estimated timeline for adoption, or (vii) a realization value.

7. The computer-implemented method of claim 1, further comprising:
extracting, by the one or more processors, the portion of the change data from the change data;
creating, by the one or more processors, a formatted input that includes a plurality of prompts for the persona model based on the portion of the change data; and
inputting, by the one or more processors, the formatted input into the persona model as part of the portion of the change data.

8. The computer-implemented method of claim 1, further comprising:
receiving, at the one or more processors, a first verbal communication of the portion of the change data;
converting, by the one or more processors, the first verbal communication to a first text string representing the portion of the change data;
generating, by the one or more processors executing the persona model, the response to the portion of the change data as a second text string;
converting, by the one or more processors, the second text string to a second verbal communication; and
causing, by the one or more processors, the second verbal communication to be conveyed to the user.

9. A system for simulating transformation adoption, comprising:
one or more processors; and
a non-transitory computer-readable memory coupled to the one or more processors and the user interface, the memory storing instructions thereon that, when executed by the one or more processors, cause the one or more processors to:
receive change data associated with an organizational change anticipated to affect members of a first group,
input a portion of the change data into a persona model configured to generate responses representative of the first group, wherein the persona model is trained using a plurality of training change data and a plurality of group data as inputs to output a plurality of training responses,
generate, by executing the persona model, a response to the portion of the change data, and
output the response for display to a user.

10. The system of claim 9, wherein the instructions, when executed, further cause the one or more processors to:
input the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments;
generate, by executing the tracking model, a performance value corresponding to the response generated by the persona model;
compare, by executing the tracking model, the performance value with a prior performance value to track the performance of the persona model; and
generate, by executing the tracking model, a recommended adjustment to the persona model based on the comparing.

11. The system of claim 9, wherein the instructions, when executed, further cause the one or more processors to:
receive updated change data associated with the organizational change;
input a portion of the updated change data into the persona model;
generate, by executing the persona model, an updated response to the portion of the updated change data, wherein the updated response represents an updated outlook of the first group with respect to the organizational change, and
output the updated response for display to the user.

12. The system of claim 9, wherein the instructions, when executed, further cause the one or more processors to:
aggregate the plurality of group data that includes one or more of: (i) an internal document, (ii) an archived email, (iii) a recorded verbal conversation, or (iv) a recorded live chat;
aggregate the plurality of training change data; and
train, by executing a training module, the persona model with the plurality of training change data and the plurality of group data as inputs to generate the plurality of training responses as outputs.

13. The system of claim 9, wherein:
the persona model includes a plurality of persona models;
each persona model of the plurality of persona models is configured to generate responses representative of a respective subset of the first group, each respective subset of the first group representing a different perspective with respect to the organizational change from every other respective subset of the first group;
each persona model of the plurality of persona models is trained using the plurality of change data and a plurality of subset group data as inputs to output a respective plurality of training responses; and
the instructions, when executed, further cause the one or more processors to:
input the portion of the change data into the plurality of persona models,
generate, by executing the plurality of trained persona models, a plurality of responses to the portion of the change data, and
output the plurality of responses for display to the user.

14. The system of claim 9, wherein the response includes at least one of: (i) a predicted subsequent response strategy to address the first group, (ii) a change receptiveness likelihood value, (iii) a predicted uptake time value, (iv) a best practices indication, (v) a successful adoption likelihood value, (vi) an estimated timeline for adoption, or (vii) a realization value.

15. The system of claim 9, wherein the instructions, when executed, further cause the one or more processors to:
extract the portion of the change data from the change data;
create a formatted input that includes a plurality of prompts for the persona model based on the portion of the change data; and
input the formatted input into the persona model as part of the portion of the change data.

16. A tangible machine-readable medium comprising instructions for simulating transformation adoption that, when executed, cause a machine to at least:
receive change data associated with an organizational change anticipated to affect members of a first group;
input a portion of the change data into a persona model configured to generate responses representative of the first group, wherein the persona model is trained using a plurality of training change data and a plurality of group data as inputs to output a plurality of training responses;
generate, by executing the persona model, a response to the portion of the change data; and
output the response for display to a user.

17. The tangible machine-readable medium of claim 16, wherein the instructions, when executed, further cause the machine to at least:
input the portion of the change data and the response to the portion of the change data into a tracking model configured to generate performance values representative of an ability of the persona model to generate responses representative of the first group, wherein the tracking model is trained using a plurality of training change data portions, a plurality of training responses, and a plurality of training performance values as inputs to output a plurality of training performance values and a plurality of training recommended adjustments;
generate, by executing the tracking model, a performance value corresponding to the response generated by the persona model;
compare, by executing the tracking model, the performance value with a prior performance value to track the performance of the persona model; and
generate, by executing the tracking model, a recommended adjustment to the persona model based on the comparing.

18. The tangible machine-readable medium of claim 16, wherein the instructions, when executed, further cause the machine to at least:
receive updated change data associated with the organizational change;
input a portion of the updated change data into the persona model;
generate, by executing the persona model, an updated response to the portion of the updated change data, wherein the updated response represents an updated outlook of the first group with respect to the organizational change; and
output the updated response for display to the user.

19. The tangible machine-readable medium of claim 16, wherein the instructions, when executed, further cause the machine to at least:
aggregate the plurality of group data that includes one or more of: (i) an internal document, (ii) an archived email, (iii) a recorded verbal conversation, or (iv) a recorded live chat;
aggregate the plurality of training change data; and
train, by executing a training module, the persona model with the plurality of training change data and the plurality of group data as inputs to generate the plurality of training responses as outputs.

20. The tangible machine-readable medium of claim 16, wherein:
the persona model includes a plurality of persona models;
each persona model of the plurality of persona models is configured to generate responses representative of a respective subset of the first group, each respective subset of the first group representing a different perspective with respect to the organizational change from every other respective subset of the first group;
each persona model of the plurality of persona models is trained using the plurality of change data and a plurality of subset group data as inputs to output a respective plurality of training responses; and
the instructions, when executed, further cause the machine to at least:
input the portion of the change data into the plurality of persona models,
generate, by executing the plurality of trained persona models, a plurality of responses to the portion of the change data, and
output the plurality of responses for display to the user.
